(19) United States
(12) Patent Application Publication
(10) Pub. No.: US 2011/0001743 A1
(43) Pub. Date: Jan. 6, 2011

(54) Drive circuit, drive method, liquid crystal display panel, liquid crystal module, and liquid cystal display device

(76) Inventor: Asahi Yamato, Osaka (JP)

Correspondence Address: HARNESS, DICKEY & PIERCE, P.L.C., P.O. BOX 8910, RESTON, VA, 20195, US

(21) Appl. No.: 12/736,084

(22) PCT Filed: Dec. 26, 2008
(86) PCT No.: PCT/JP2008/073730

§ 371 Date: Sep. 9, 2010

(30) Foreign Application Priority Data
Mar. 11, 2008 (JP) 2008-061611

(51) Int. Cl. G09G 5/00; G09G 3/36

(52) U.S. Cl. 345/212; 345/87

(57) ABSTRACT

A drive circuit drives an active matrix display section. In at least one embodiment, a COM signal generation section changes, after an end of a selection period of a pixel included in the display section, a voltage V_{COM(n)} of a COM line corresponding to the pixel. The COM signal generation section changes the voltage V_{COM(n)} in a direction opposite to a polarity of a voltage V₍ₙ₎ applied to liquid crystals in the pixel. As such, it is possible to sufficiently overshoot-drive the liquid crystals without requiring additional members which take up much space.

### TECHNICAL FIELD

The present invention relates to a drive circuit which carries out overshoot drive of liquid crystals, a drive method employing the overshoot drive, a liquid crystal display panel employing the overshoot drive, a liquid crystal module employing the overshoot drive, and a liquid crystal display device employing the overshoot drive.

### BACKGROUND ART

Conventionally, overshoot drive has been well known as a method of improving a response speed of liquid crystals in a liquid crystal display device. Examples of a technique employing such a method are disclosed in Patent Literatures 1 through 3.

Disclosed in Patent Literature 1 is:

a liquid crystal display device, including:

a data gray scale signal correction section for receiving a gray scale signal for a current frame from a data gray scale signal source, correcting the received gray scale signal by taking into consideration a gray scale signal for a previous frame and the gray scale signal for the current frame, and then outputting the corrected gray scale signal;

a data driver section for converting an image signal into a data voltage corresponding to the corrected gray scale signal outputted from the data gray scale signal correction section, and then outputting the image signal;

a gate driver section for sequentially supplying scanning signals; and

a liquid crystal display panel including:
a large number of gate lines which convey the scanning signals;
a large number of data lines each of which conveys the image signal, the large number of data lines intersecting with the large number of gate lines in an insulated manner; and
a large number of pixels provided in matrix,
the large number of pixels being provided in respective regions defined by the large number of gate lines and the large number of data lines, and including respective switching elements each of which is connected to corresponding one of the large number of gate lines and to corresponding one of the large number of data lines.

According to the liquid crystal display device disclosed in Patent Literature 1, the data gray scale signal correction section is located at a previous stage of the data driver. The data gray scale signal correction section includes a frame memory, in which data based on which to carry out a calculation for the overshoot drive is stored in advance. The data gray scale signal correction section corrects inputted data in accordance with the data stored in the frame memory so as to obtain a corrected signal, and then supplies the corrected signal to the data driver. The corrected signal is for applying an overshoot-driven voltage to a liquid crystal layer. In this way, the overshoot drive is carried out.

However, the technique disclosed in Patent Literature 1 entails the following problem. According to the liquid crystal display device of Patent Literature 1, it is indeed possible to carry out the overshoot drive. However, such a liquid crystal display device has an increased size and a higher production cost, because the data gray scale signal correction section requires special members so as to carry out the overshoot drive. Specifically, the data gray scale signal correction section needs to incorporate a certain frame memory and a certain correction circuit, which generally take up much space. This increases a size of a circuit mounting area, thus increasing the size and production cost of the liquid crystal display device.

In order to solve the above problem, there have been developed techniques capable of carrying out the overshoot drive without requiring additional members which take up much space. Specific examples of such techniques are disclosed in Patent Literatures 2 and 3. The following description discusses such specific examples.

The technique disclosed in Patent Literature 2 has solved the problem of Patent Literature 1, by making use of driving of a storage capacitor. Specifically, Patent Literature 2 discloses:

a method for driving an electro-optic device including:

pixels provided at respective intersections of a plurality of scanning lines extending in a line direction and a plurality of data lines extending in a column direction,

the pixels each including (i) a pixel capacitor and a switching element which are electrically connected to each other in series and provided between corresponding one of the plurality of scanning lines and corresponding one of the plurality of data lines and (ii) a storage capacitor electrically connected between (a) one, of the plurality of scanning lines, which is driven immediately before the corresponding one of the scanning lines and (b) a connection point of the pixel capacitor and the switching element,

said method, comprising:

sequentially driving the plurality of scanning lines in a predetermined order;

applying, when one of the scanning signal lines is driven, a selective voltage to the one of the plurality of scanning lines so as to cause the switching element to be conductive and thereafter; applying a non-selective voltage to the one of the plurality of scanning lines so as to cause the switching element to be not conductive and thereafter; applying the selective voltage to another one, of the plurality of scanning lines, which is driven subsequent to the one of the plurality of scanning lines and thereafter; shifting the non-selective voltage applied to the one of the plurality of scanning lines; and

supplying, to ones, of the pixels, which correspond to driven one of the plurality of scanning signal lines, data signals each indicative of a voltage corresponding to a gray scale level of each of the pixels, the data signals being supplied via the plurality of data lines.

According to the method, the storage capacitor in one pixel is driven when the one pixel is driven. As such, the overshoot drive is carried out.

The overshoot drive in accordance with the technique disclosed in Patent Literature 3 is carried out by making use of driving of the storage capacitor, as is the case with Patent Literature 2. Specifically, Patent Literature 3 discloses a method of driving an AC-driven active matrix liquid crystal display device configured as below. When a switching element is selected in response to a gate signal supplied from a gate line, a pixel electrode corresponding to the switching element receives a source signal supplied from a source line. As a result, the pixel electrode is charged with electricity, and thereby (i) a liquid crystal capacitance defined by the pixel electrode and a common electrode and (ii) a corresponding storage capacitance are charged with electricity.

According to this method, response speed of liquid crystals is excellent when a moving image is displayed.

A first example of the overshoot drive in accordance with the conventional art is described in more detail with reference to FIGS. 20 and 21. FIG. 20 illustrates a configuration of a main part of a liquid crystal module 100 in accordance with the conventional art. As illustrated in FIG. 20, the liquid crystal module 100 includes a drive circuit and a display section 102.

The drive circuit of the liquid crystal module 100 drives the display section 102, and includes a control section 110, a drive voltage generation section 111, a gate signal generation section 112, a source signal generation section 113, a CS signal generation section 114, and a COM signal generation section 115. The drive circuit receives a video signal, a sync signal, and a power supply voltage, which are supplied from an upper circuit (not illustrated). Then, the drive circuit generates, on the basis of the signals and voltage received above, various signals for driving the display section 102. Thereafter, the drive circuit transmits the various signals to the display section 102.

The display section 102 is driven by the drive circuit. In this way, the display section 102 displays an image thereon. The display section 102 in FIG. 20 is illustrated so as to describe mainly its wiring connections. The display section 102 includes a plurality of gate lines 122, a plurality of source lines 123, a plurality of CS lines 24, and a plurality of COM lines 125. The plurality of CS lines 124 are provided in such a way that their voltages are identical over the whole display section 2. Similarly, the plurality of COM lines 125 are provided in such a way that their voltages are identical over the whole display section 2.

FIG. 21 illustrates waveforms of voltages (electric potentials) at various points in each pixel as observed when the display section 102 is driven by the drive circuit of the conventional art. Specifically, FIG. 21 illustrates waveforms of a voltage V_{Gate} of each of the plurality of gate lines 122, a voltage V_{Source} of the plurality of source lines 123, a voltage V_{CS} of the plurality of CS lines 124, and a voltage V_{COM} of each of the plurality of COM lines 125.

In the following, a description is given with reference to FIG. 21. The source signal generation section 113 sends out, during a certain horizontal scanning period (n-th horizontal scanning period), source signals to the plurality of source lines 123. Further, the gate signal generation section 112 sends out, at a timing at which the source signals are sent out, a gate signal having a rectangular waveform to corresponding one of the plurality of gate lines 122 (i.e., a gate line 122 [n]). Note here that a waveform of a voltage V_{Gate(n)} of the gate line 122 (n) rises in a positive direction. Then, the waveform of the voltage V_{Gate(n)} thus risen remains constant for a while, and then finally returns to a value observed before the rise of the waveform. The pixel is in a selected state during a period from the timing at which the waveform of the voltage V_{Gate(n)} rises in the positive direction to a timing at which the voltage V_{Gate(n)} returns to the value observed before the rise of the waveform (this period is referred to as a selection period of the pixel).

As described above, the gate signal is supplied to the gate line 122 (n). Accordingly, a source and a drain of each TFT connected to the gate line 122 (n) become conductive each other, and thus the drain receives a constant drain voltage V_{Drain}. In the meantime, the COM signal generation section 115 is supplying COM signals having a constant voltage to the respective plurality of COM lines 125. That is, each of the plurality of COM lines 125 is receiving the voltage V_{COM}. Accordingly, liquid crystals of the pixel receive a difference (voltage V) between the drain voltage V_{Drain} of the TFT and a voltage V_{COM(n)} of corresponding one of the plurality of COM lines 125.

After the end of the selection period of the pixel, the CS signal generation section 114 reverses a polarity of the voltage V_{CS}. In this way, the voltage V applied to the pixel is adjusted to an appropriate level, and thus the pixel is overshoot-driven.

A second example of the overshoot drive in accordance with the conventional art is described with reference to FIGS. 22 and 23. FIG. 22 illustrates a configuration of a main part of a liquid crystal display module 100a in accordance with the conventional art. As illustrated in FIG. 22, the liquid crystal module 100a includes a drive circuit and a display section 102a.

The drive circuit of the liquid crystal module 100a drives the display section 102a, and includes a control section 110, a drive voltage generation section 111, a gate signal generation section 112, a source signal generation section 113, a CS signal generation section 114, and a COM signal generation section 115. The drive circuit receives a video signal, a sync signal, and a power supply voltage, which are supplied from an upper circuit (not illustrated). Then, the drive circuit generates, on the basis of the signals and voltage received above, various signals for driving the display section 102a. Thereafter, the drive circuit transmits the various signals to the display section 102a.

The display section 102a is driven by the drive circuit. In this way, the display section 102a displays an image thereon. The display section 102a in FIG. 22 is illustrated so as to describe mainly its wiring connections. The display section 102a includes a plurality of gate lines 122, a plurality of source lines 123, a plurality of CS lines 124, and a plurality of COM lines 125. The plurality of CS lines 124 correspond to the respective plurality of gate lines 122, and are electrically insulated from one another. This makes it possible for the CS signal generation section 114 to individually drive each of the plurality of CS lines 24. On the other hand, the plurality of COM lines 125 are provided in such a way that their voltages are identical over the whole display section 102a.

### (Waveforms of Voltages at Pixel)

FIG. 23 illustrates waveforms of voltages (electric potentials) at various points in each pixel as observed when the display section 102a is driven by the drive circuit of the conventional art. Specifically, FIG. 23 illustrates waveforms of a voltage V_{Gate} of each of the plurality of gate lines 122, a voltage V_{Source} of the plurality of source lines 123, a voltage V_{CS} of each of the plurality of CS lines 124, and a voltage V_{COM} of each of the plurality of COM lines 125.

In the following, a description is given with reference to FIG. 23. The source signal generation section 113 sends out, during a certain horizontal scanning period (n-th horizontal scanning period), source signals to the plurality of source lines 123. Further, the gate signal generation section 112 sends out, at a timing at which the source signals are sent out, a gate signal having a rectangular waveform to corresponding one of the plurality of gate lines 122 (i.e., a gate line 122 [n]). Note here that an waveform of a voltage V_{Gate(n)} of the gate line 122 (n) rises in a positive direction. Then, the waveform of the voltage V_{Gate(n)} thus risen remains constant for a while, and then finally returns to a value observed before the rise of the waveform. The selection period of the pixel here is from the timing at which the waveform of the voltage V_{Gate(n)} rises in the positive direction to a timing at which the voltage V_{Gate(n)} returns to the value observed before the rise of the waveform.

As described above, the gate signal was supplied to the gate line 122 (n). Accordingly, a source and a drain of each TFT connected to the gate line 122 (n) become conductive each other, and thus the drain receives a constant drain voltage V_{Drain}. In the meantime, the COM signal generation section 115 is supplying COM signals having a constant voltage to the respective plurality of COM lines 125. That is, each of the plurality of COM lines 125 is receiving the voltage V_{COM}. Accordingly, liquid crystals of the pixel receive a difference (voltage V) between the drain voltage V_{Drain} of the TFT and a voltage V_{COM(n)} of corresponding one of the plurality of COM lines 125.

After the end of the selection period of the pixel, the CS signal generation section 114 reverses a polarity of the voltage V_{CS}. In this way, the voltage V applied to the pixel is adjusted to an appropriate level, and thus the pixel is overshoot-driven.

Patent Literature 1

Japanese Patent Application Publication, Tokukai, No. 2001-265298 A (Publication Date: Sep. 28, 2001)

Patent Literature 2

Japanese Patent Application Publication, Tokukai, No. 2006-163104 A (Publication Date: Jun. 22, 2006)

Patent Literature 3

Japanese Patent Application Publication, Tokukai, No. 2003-279929 A (Publication Date: Oct. 2, 2003)

### SUMMARY OF INVENTION

However, each of the conventional arts described earlier involves a problem that the effect of the overshoot drive of pixels is insufficient. Indeed, the above conventional arts each have an advantage that there is no need to include any additional member which takes up much space. However, actually, the overshoot drive of such conventional arts cannot sufficiently improve response speed of liquid crystals, and thus they are not suited for practical use.

The present invention has been made in view of the above problems, and an object of the present invention is to provide a drive circuit which overshoot-drives liquid crystals sufficiently without requiring additional members which take up much space, a drive method employing the overshoot drive, a liquid crystal display panel employing the overshoot drive, a liquid crystal module employing the overshoot drive, and a liquid crystal display device employing the overshoot drive.

### (Liquid Crystal Drive Circuit)

In order to attain the above object, a liquid crystal drive circuit in accordance with the present invention is a drive circuit for driving an active matrix liquid crystal display panel, including: a voltage-changing section for changing, after an end of a selection period of a pixel in the active matrix liquid crystal display panel, a voltage of a common electrode of the pixel, the voltage-changing means changing the voltage of the common electrode in a direction opposite to a polarity of a voltage applied to liquid crystals in the pixel.

According to the configuration, in the active matrix liquid crystal display panel, the voltage of the common electrode corresponding to the pixel is changed, after the end of the selection period of the pixel, in the direction opposite to the polarity of the voltage applied to the liquid crystals in the pixel. As a result of the change in the voltage of the common electrode, the liquid crystal applied voltage is further shifted in a direction of its polarity. For example, if the liquid crystal applied voltage is positive in polarity, then the liquid crystal applied voltage is further shifted in the positive direction, and if the liquid crystal applied voltage is negative in polarity, then the liquid crystal applied voltage is further shifted in the negative direction. Note here that an amount by which the liquid crystal applied voltage is shifted exhibits a characteristic same as that as observed when the overshoot drive of the liquid crystal display panel is carried out. That is, when a display state of the pixel changes from a state where the liquid crystal applied voltage is small to a state where the liquid crystal applied voltage is large, the following occurs. If the liquid crystal applied voltage is positive in polarity, then the liquid crystal applied voltage is further shifted in the positive direction. On the other hand, if the liquid crystal applied voltage is negative in polarity, then the liquid crystal applied voltage is further shifted in the negative direction. In this way, the liquid crystal display panel is overshoot-driven. Further, unlike overshoot drive employing a frame memory, the overshoot drive having this configuration does not require additional members which take up much space.

In addition, the overshoot drive attained by this configuration makes it possible to increase an amount (ΔV) of the change in the liquid crystal applied voltage, as compared to overshoot drive (of the conventional art) attained by changing a voltage of a storage capacitor. This is because, according to the overshoot drive attained by this configuration, parasitic capacitances (e.g., a capacitance defined by a gate and a drain of a switching element (TFT) and a capacitance defined by a source line and a drain) contribute to the increase in the ΔV. In contrast, according to the overshoot drive of the conventional art, such parasitic capacitances do not at all contribute to the increase in the ΔV. As such, the drive circuit having this configuration makes it possible to sufficiently overshoot-drive the liquid crystals, unlike the conventional art.

As described above, the drive circuit having this configuration makes it possible to sufficiently overshoot-drive the liquid crystals without requiring additional members which take up much space.

In order to attain the above object, a drive method in accordance with the present invention is a method of driving an active matrix liquid crystal display panel, including the step of: changing, after an end of a selection period of a pixel in the active matrix liquid crystal display panel, a voltage of a common electrode of the pixel, the voltage of the common electrode being changed in a direction opposite to a polarity of a voltage applied to liquid crystals in the pixel.

According to the configuration, it is possible to attain an effect same as that attained by the drive circuit in accordance with the present invention.

### (Another Drive Circuit)

In order to attain the above object, a liquid crystal drive circuit in accordance with the present invention is a drive circuit, for driving an active matrix liquid crystal display panel, wherein, after an end of a selection period of a pixel in the active matrix liquid crystal display panel, a voltage of a common electrode of the pixel is changed in a direction opposite to a polarity of a voltage applied to liquid crystals in the pixel.

According to the configuration, it is possible to provide the drive circuit capable of sufficiently overshoot-driving the liquid crystals, without requiring additional members which take up much space.

### (Liquid Crystal Display Panel)

In order to attain the above object, a liquid crystal display panel in accordance with the present invention is an active matrix liquid crystal display panel, including: a liquid crystal panel substrate, directly on which any of the above drive circuits is formed.

According to the configuration, it is possible to provide the drive circuit capable of sufficiently overshoot-driving the liquid crystals without requiring additional members which take up much space.

### (Liquid Crystal Module)

In order to attain the above object, a liquid crystal module in accordance with the present invention is a liquid crystal module, including: an active matrix liquid crystal display panel; and any of the above drive circuits.

According to the configuration, it is possible to provide the drive circuit capable of sufficiently overshoot-driving the liquid crystals without requiring additional members which take up much space.

### (Liquid Crystal Display Device)

In order to attain the above object, a liquid crystal display device in accordance with the present invention is a liquid crystal display device, including: the liquid crystal display panel above; or the liquid crystal module above.

According to the configuration, it is possible to provide the drive circuit capable of sufficiently overshoot-driving the liquid crystals without requiring additional members which take up much space.

For a fuller understanding of the nature and advantages of the invention, reference should be made to the ensuing detailed description taken in conjunction with the accompanying drawings.

### BRIEF DESCRIPTION OF DRAWINGS

FIG. 1 illustrates a configuration of a main part of a liquid crystal display module in accordance with Embodiment 1.

FIG. 2 illustrates a configuration of a main part of a display section included in the liquid crystal module in accordance with Embodiment 1.

FIG. 3 illustrates an equivalent circuit, for liquid crystal, of the display section.

FIG. 4 illustrates waveforms of voltages (electric potentials) at various points in each pixel as observed when the display section is driven by a drive circuit.

FIG. 5 illustrates waveforms of V_{Gate(n)}, V_{Source}, V_{COM(n)}, and V_{CS} as observed in one of the pixels.

FIG. 6 illustrates an example of an effect of overshoot drive of the present invention.

FIG. 7 illustrates another example of the effect of the overshoot drive of the present invention.

FIG. 8 illustrates waveforms of voltages (electric potentials) at various points in each pixel as observed in a case where a drive circuit carries out CS drive as well as COM drive.

FIG. 9 illustrates a configuration of a main part of a liquid crystal module a in accordance with Embodiment 2.

FIG. 10 illustrates an equivalent circuit, for liquid crystal, of a display section.

FIG. 11 illustrates waveforms of voltages (electric potentials) at various points in each pixel as observed in a case where a drive circuit carries out CS drive as well as COM drive.

FIG. 12 illustrates waveforms of V_{Gate(n)}, V_{Source}, V_{COM(n)}, and V_{CS(n)} as observed in one of the pixels.

FIG. 13 illustrates a configuration of a main part of a liquid crystal module in accordance with Embodiment 3.

FIG. 14 illustrates an equivalent circuit, for liquid crystal, of a display section.

FIG. 15 illustrates waveforms of voltages (electric potentials) at various points in each pixel as observed in a case where a drive circuit carries out COM drive.

FIG. 16 illustrates waveforms of voltages (electric potentials) at various points in each pixel as observed in a case where the drive circuit carries out COM drive and CS drive.

FIG. 17 illustrates a configuration of a main part of a liquid crystal module in accordance with Embodiment 4.

FIG. 18 illustrates an equivalent circuit, for liquid crystal, of a display section.

FIG. 19 illustrates waveforms of voltages (electric potentials) at various points in each pixel as observed in a case where a drive circuit carries out COM drive and CS drive.

FIG. 20 illustrates a configuration of a main part of a liquid crystal module in accordance with a conventional art.

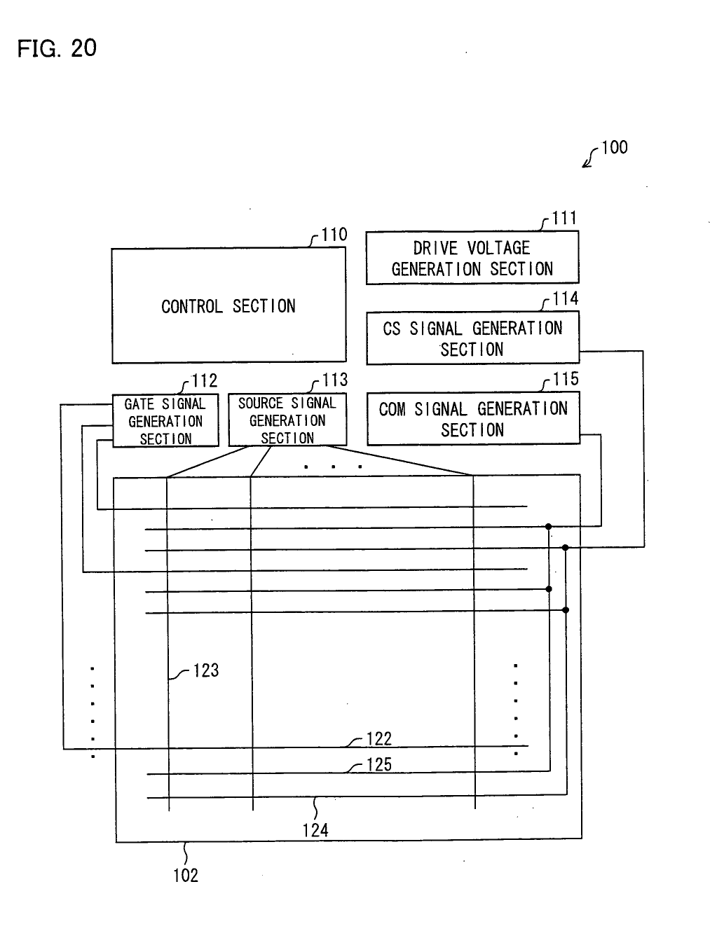

FIG. 21 illustrates waveforms of voltages (electric potentials) at various points in each pixel as observed when a display section is driven by a drive circuit in accordance with the conventional art.

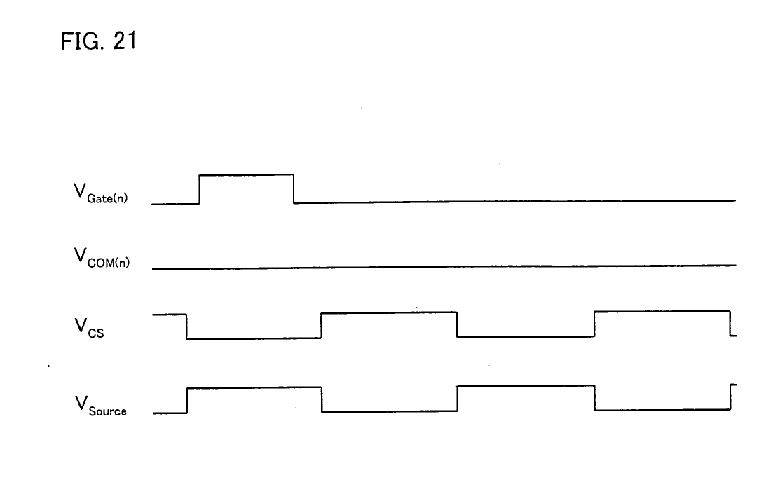

FIG. 22 illustrates a configuration of a main part of another liquid crystal module in accordance with a conventional art.

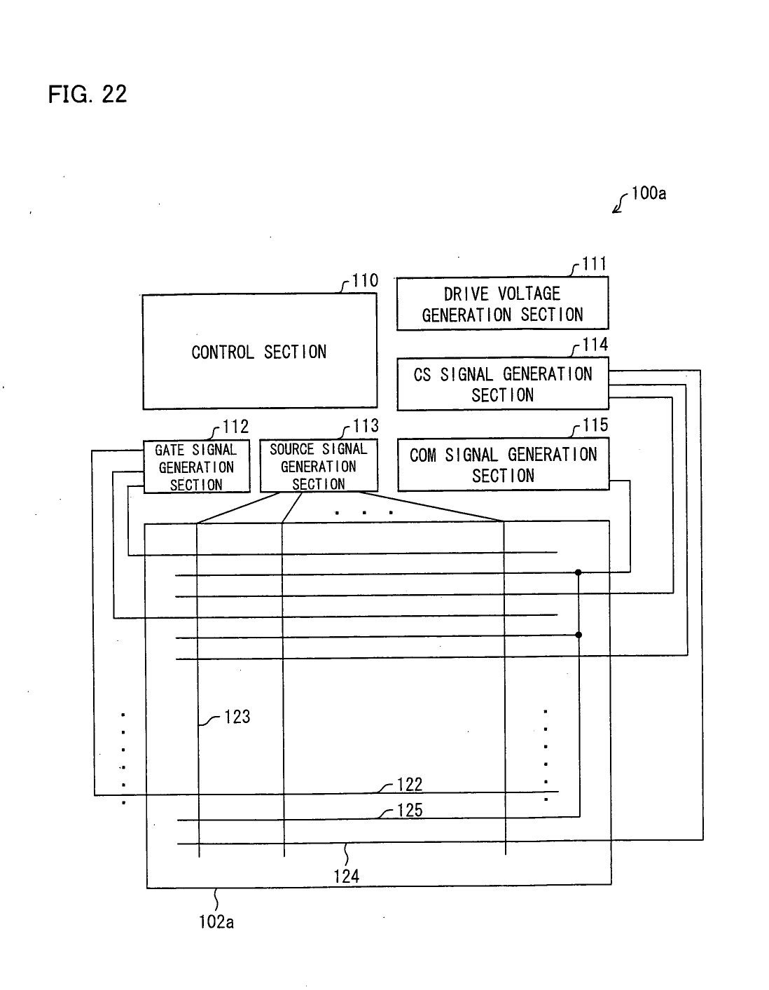

FIG. 23 illustrates waveforms of voltages (electric potentials) at various points in each pixel as observed when a display section is driven by another drive circuit in accordance with the conventional art.

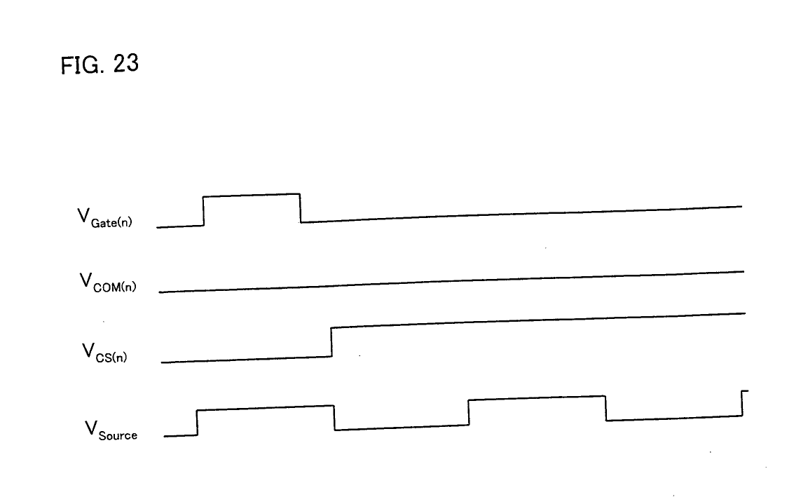

### REFERENCE SIGNS LIST

1 Drive Circuit
2 Display Section (Liquid Crystal Display Panel)
10 Control Section
11 Drive Voltage Generation Section
12 Gate Signal Generation Section
13 Source Signal Generation Section
14 CS Signal Generation Section (Storage Capacitor Drive Line Voltage-Changing Section)
15 COM Signal Generation Section (Voltage-Changing Section)
22 Gate Line
23 Source Line
24 CS Line (Storage Capacitor Drive Line)
25 COM Line (Common Electrode)
30 TFT
50 Liquid Crystal Module

### DESCRIPTION OF EMBODIMENTS

### Embodiment 1

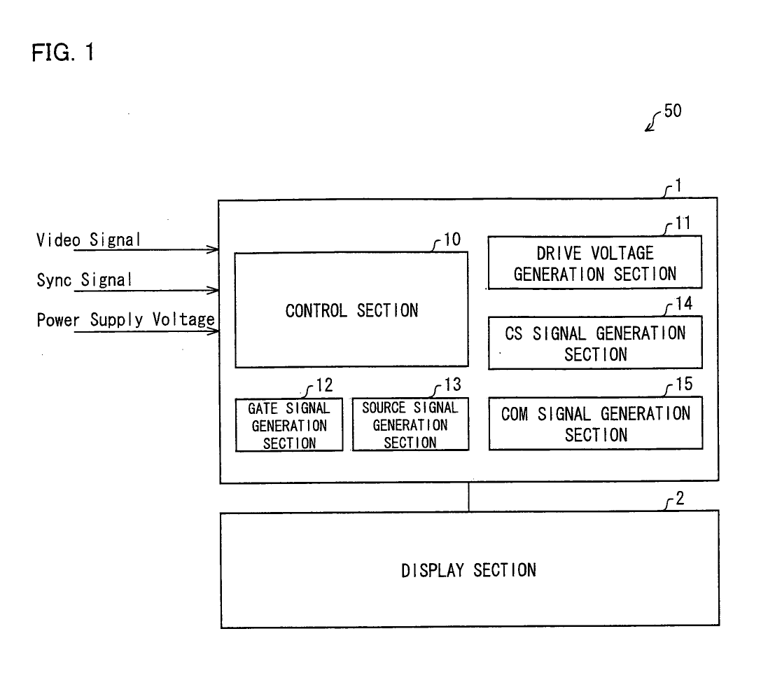

One embodiment of the present invention is described below with reference to FIGS. 1 through 8.

### (Configuration of Liquid Crystal Module 50)

FIG. 1 illustrates a configuration of a main part of a liquid crystal module 50 in accordance with the present embodiment. As illustrated in FIG. 1, the liquid crystal module 50 includes a drive circuit 1 and a display section 2. The liquid crystal module 50 serves as a constituent part of a liquid crystal display device (not illustrated).

The drive circuit 1 of the liquid crystal module 50 drives the display section 2, and includes a control section 10, a drive voltage generation section 11, a gate signal generation section 12, a source signal generation section 13, a CS signal generation section 15, and a COM signal generation section 14 (see FIG. 1). The drive circuit 1 receives a video signal, a sync signal, and a power supply voltage, which are supplied from an upper circuit (not illustrated). Then, the drive circuit 1 generates, on the basis of the signals and voltage received above, various signals for driving the display section 2. Thereafter, the drive circuit 1 transmits the various signals to the display section 2.

The drive circuit 1 of the present embodiment is provided on a circuit board (liquid crystal panel substrate) connected with the display section 2. This does not mean that a position of the drive circuit 1 in the liquid crystal module 50 is limited to a particular position. The drive circuit 1 can be incorporated in an LSI mounted on the display section 2. Alternatively, the drive circuit 1 can be incorporated in the display section 2.

### (Display Section 2)

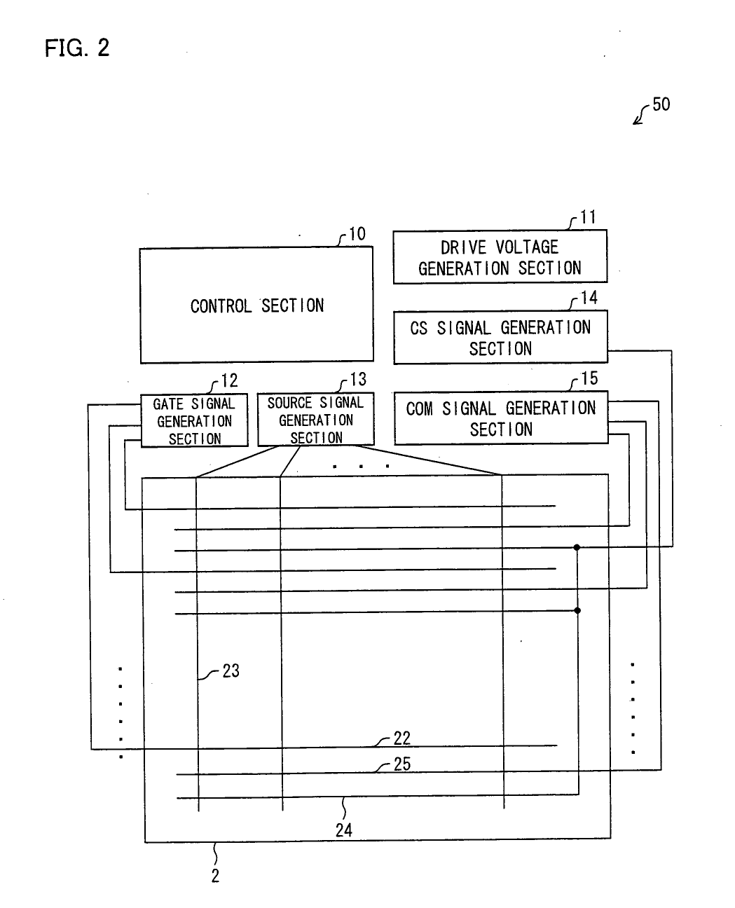

The display section 2 is driven by the drive circuit 1. In this way, the display section 2 displays an image thereon. The display section 2 is an active matrix liquid crystal display panel. FIG. 2 illustrates a configuration of a main part of the display section 2 included in the liquid crystal module 50 in accordance with the present embodiment. The display section 2 in FIG. 2 is illustrated so as to describe mainly its wiring connections. The display section 2 includes a plurality of gate lines 22, a plurality of source lines 23, a plurality of CS lines 24, and a plurality of COM lines 25. The plurality of gate lines 22 extend in parallel with one another, and intersect with the plurality of source lines 23. The plurality of source lines 23 also extend in parallel with one another. The plurality of CS lines 24 and the plurality of COM lines 25 extend in parallel with the plurality of gate lines 22. The plurality of COM lines 25 are equivalent to a so-called common electrode (counter electrode). The plurality of CS lines 24 correspond to the respective plurality of gate lines 22, and also the plurality of COM lines correspond to the respective plurality of gate lines 22.

Note here that the configuration shown in FIG. 2 is merely an example, and therefore the present invention is not limited to the configuration. For example, the plurality of COM lines 25 can be a single electrode shared by all the plurality of gate lines 22. Further, voltage input ports of the plurality of CS lines 24 and voltage input ports of the plurality of COM lines 25 can be provided on the same side as those of the plurality of gate lines 22.

### (Equivalent Circuit for Liquid Crystal of Display Section 2)

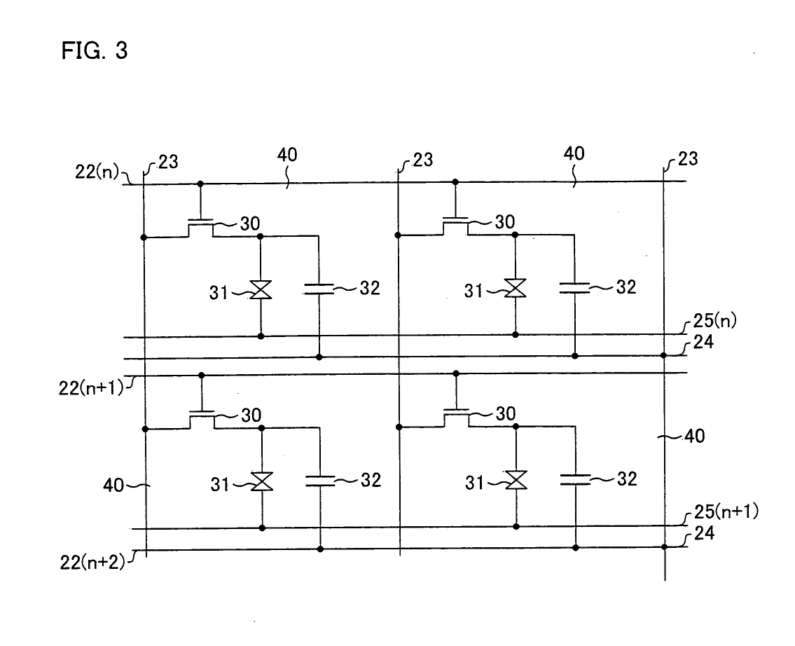

FIG. 3 illustrates an equivalent circuit, for liquid crystal, of the display section 2. As illustrated in FIG. 3, the display section 2 includes a plurality of pixels 40 arrayed in matrix. Each of the plurality of pixels 40 is equivalent to a region defined by neighboring ones of the plurality of gate lines 22 and neighboring ones of the plurality of source lines 23. Note that one pixel 40 is the smallest unit for displaying an image on the display section 2.

Each of the plurality of pixels 40 includes a TFT 30, a liquid crystal capacitor 31, and a storage capacitor 32. The liquid crystal capacitor 31 and the storage capacitor 32 may be hereinafter referred to as C_{LC} and C_{CS}, respectively. The TFT 30 has a gate which is connected with corresponding one of the plurality of gate lines 22, and a source which is connected with corresponding one of the plurality of source lines 23. The TFT 30 further has a drain which is connected with one end of the liquid crystal capacitor 31 and with one end of the storage capacitor 32. The other end of the liquid crystal capacitor 31 is connected with corresponding one of the plurality of COM lines 25. The other end of the storage capacitor 32 is connected with corresponding one of the plurality of CS lines 24.

Further, each of the plurality of pixels 40 has (i) a parasitic capacitance C_{gd} defined by the gate and drain and (ii) a parasitic capacitance C_{sd} defined by the source and drain, although they are not illustrated.

### (Generation and Output of Signals)

The control section 10 calculates, on the basis of the inputted video signal and sync signal, a timing at which the drive circuit 1 sends out signals to the display section 2. Then, the control section 10 supplies the video signal and the calculated timing to the gate signal generation section 12, the source signal generation section 13, the CS signal generation section 14, and the COM signal generation section 15. The above sections generate, on the basis of the calculated timing and the video signal thus supplied, signals that they should transmit. Then, the sections transmit the generated signals to the display section 2. In the following, detailed description thereof is provided.

The drive voltage generation section 11 receives a power supply voltage, and converts the received power supply voltage into a drive voltage for liquid crystals. Specifically, the drive voltage generation section 11 converts the received power supply voltage into a drive voltage suitable for driving of the plurality of pixels 40 in the display section 2. Then, the drive voltage generation section 11 supplies the drive voltage to the gate signal generation section 12, the source signal generation section 13, the CS signal generation section 14, and the COM signal generation section 15.

The gate signal generation section 12 generates, on the basis of the supplied sync signal and the drive voltage, a gate signal to be supplied to the gate of the TFT 30 of each of the plurality of pixels 40. Then, the gate signal generation section 12 supplies the gate signal to each of the plurality of gate lines 22.

The source signal generation section 13 generates, on the basis of the supplied video signal and the drive voltage, a source signal to be supplied to the source of the TFT 30 of each of the plurality of pixels 40. Then, the source signal generation section 13 supplies the source signal to each of the plurality of source lines 23.

The CS signal generation section 14 generates, on the basis of the supplied sync signal and the drive voltage, a storage capacitor signal to be supplied to the storage capacitor 32 of each of the plurality of pixels 40. Then, the CS signal generation section 14 supplies the storage capacitor signal to each of the plurality of CS lines 24.

The COM signal generation section 15 generates, on the basis of the supplied sync signal and the drive voltage, a COM signal to be supplied to a COM electrode (not illustrated) in each of the plurality of pixels 40. Then, the COM signal generation section 15 supplies the COM signal to each of the plurality of COM lines 25.

### (Individual Driving of Each of COM Lines 25)

The plurality of COM lines 25 in the display section 2 correspond to the respective plurality of gate lines 22. Further, the plurality of COM lines are electrically insulated from one another in the display section 2. For example, ones, of the plurality of pixels 40, defined by a gate line 22 (n) and a gate line 22 (n+1) are provided with a COM line 25 (n). The COM line 25 (n) is electrically insulated from a COM line 25 (n+1).

The COM signal generation section 15 supplies the COM signals in such a way that an independent COM signal is supplied to each of the plurality of COM lines 25. In this way, a voltage of each of the plurality of COM lines 25 is changed individually and independently. In other words, a voltage of one certain COM line 25 can be changed without making a significant effect on voltages of the other COM lines 25.

Alternatively, the plurality of COM lines 25 can be provided in such a way as to correspond to respective gate line groups, each of which consists of a plurality of gate lines 22 that receive voltages having an identical polarity. In this case, the COM signal generation section 15 supplies an independent COM signal to each of the plurality of COM lines 25, which correspond to the respective gate line groups each consisting of the plurality of gate lines 22 that receive voltages having an identical polarity. In this way, a voltage of each of the plurality of COM lines 25 is individually changed. According to this configuration, it is possible to selectively change voltages of COM lines that correspond to ones, of the plurality of pixels 40, which are to be scanned. That is, as to pixels 40 (i.e., pixels 40 that are not to be scanned) other than the pixels 40 to be scanned, a COM line 25 corresponding thereto keeps its voltage constant. Accordingly, the pixels 40 which are not to be scanned receive little effect from the above voltage change, and thus the display section 2 can be driven in a more preferable manner.

### (Waveforms of Voltages in Pixel 40)

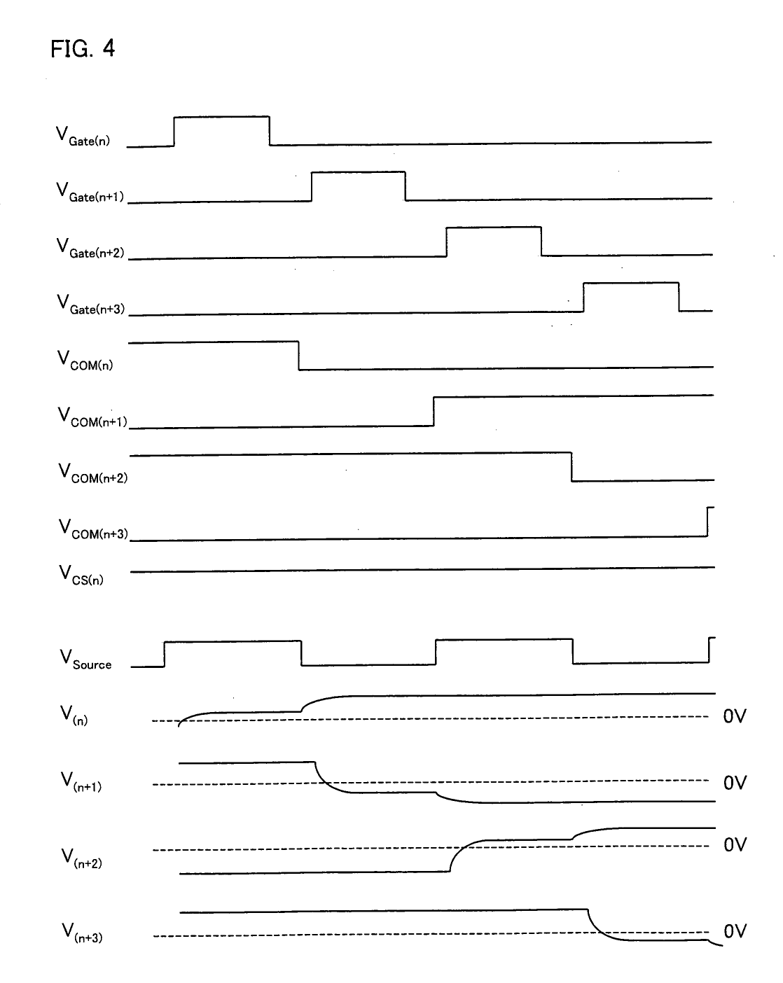

FIG. 4 illustrates waveforms of voltages (electric potentials) at various points in each of the plurality of pixels 40 as observed when the display section 2 is driven by a drive circuit 1. Specifically, FIG. 4 illustrates a voltage V_{Gate} of each of the plurality of gate lines 22, a voltage V_{Source} of the plurality of source lines 23, a voltage V_{CS} of each of the plurality of CS lines 24, a voltage V_{COM} of each of the plurality of COM lines 25, and a voltage V applied to liquid crystals in each of the plurality of pixels 40. In FIG. 4, each of the waveform of the voltage V_{Gate} and the waveform of the voltage V_{COM} is illustrated for sequentially-arranged four lines (n-th line through [n+3]-th line).

In the following, a description is given with reference to FIG. 4. The source signal generation section 13 sends out, during a certain horizontal scanning period (n-th horizontal scanning period), source signals to the plurality of source lines 23. Further, the gate signal generation section 12 sends out, at a timing at which the source signals are sent out, a gate signal having a rectangular waveform to corresponding one of the plurality of gate lines 22 (i.e., a gate line 22 [n]). Note here that a waveform of a voltage V_{Gate(n)} of the gate line 22 (n) rises in a positive direction. Then, the waveform of the voltage V_{Gate(n)} thus risen remains constant for a while, and then finally returns to a value observed before the rise of the waveform. The pixel 40 is in a selected state during a period from the timing at which the waveform of the voltage V_{Gate(n)} rises in the positive direction to a timing at which the voltage V_{Gate(n)} returns to the value observed before the rise of the waveform (this period is referred to as a selection period of pixel 40).

As described above, the gate signal is supplied to the gate line 22 (n). Accordingly, a source and a drain of each TFT 30 connected to the gate line 22 (n) become conductive each other, and thus the drain receives a constant drain voltage V_{Drain}. In the meantime, the COM signal generation section 15 is supplying a COM signal having a constant voltage to a COM line 25 (n). That is, the COM line 25 (n) is receiving the voltage V_{COM(n)}. Accordingly, liquid crystals of the pixel 40 receive a difference (voltage V [n], hereinafter referred to as a liquid crystal applied voltage V [n]) between the drain voltage V_{Drain} of the TFT 30 and the voltage V_{COM(n)} of the COM line 25 (n). According to FIG. 4, the liquid crystal applied voltage V (n) rises in a positive direction immediately after the rise of the voltage V_{Gate}. Note here that transmittance of liquid crystal of the pixel 40 changes according to a polarity and an amplitude of the liquid crystal applied voltage V (n).

### (Overshoot Drive)

Immediately after the end of the selection period of the pixel 40, the COM signal generation section 15 changes the V_{COM(n)} in a direction opposite to a polarity of a target level of the voltage V (n). According to FIG. 4, a timing of the change in the V_{COM(n)} is same as the timing of the change in the V_{Source} (note however that these timings do not necessarily have to be identical). As a result of the change in the V_{COM(n)}, the V (n) here is further shifted in the positive direction. Note here that an amount by which the V (n) is shifted in the positive direction exhibits a characteristic same as that as observed when the overshoot drive of the display section 2 is carried out. That is, when a display state of the pixel 40 changes from a state where the liquid crystal applied voltage is small to a state where the liquid crystal applied voltage is large, the following occurs. If the liquid crystal applied voltage is positive in polarity, then the liquid crystal applied voltage is further shifted in the positive direction. On the other hand, if the liquid crystal applied voltage is negative in polarity, then the liquid crystal applied voltage is further shifted in the negative direction. In this way, the pixel 40 is overshoot-driven.

It should be noted that the timing of the change in the V_{COM(n)} may fall within one horizontal scanning period corresponding to the pixel 40. In this case, it is possible to boost an effect of the change in the V_{COM(n)}. Further, the timing of the change preferably falls within two horizontal scanning periods subsequent to the one horizontal scanning period that corresponds to the pixel 40. This makes it possible to prevent display image distortion in the display section 2.

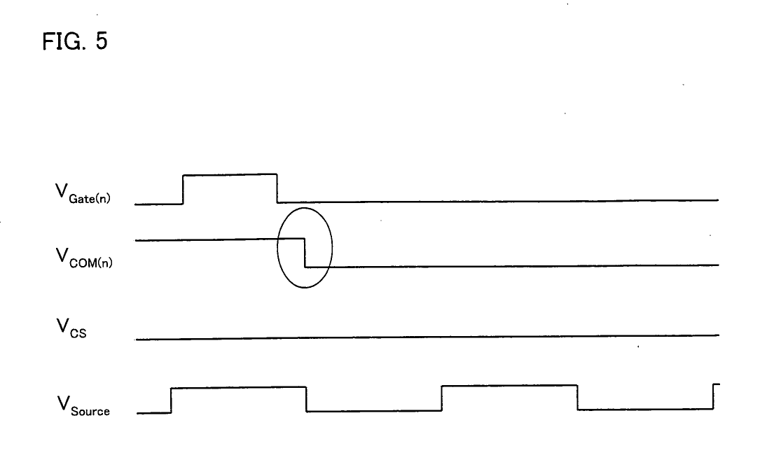

The drive method as so far described is hereinafter referred to as “COM drive”. That is, the COM drive is carried out by changing, after the end of the selection period of the pixel 40, the voltage V_{COM} of a COM line 25 corresponding to the pixel 40 in a direction opposite to a polarity of the liquid crystal applied voltage V. FIG. 5 illustrates waveforms of voltages in each of pixels 40 connected with one gate line 22 (n) as observed in a case of the COM drive. Specifically, FIG. 5 illustrates waveforms of V_{Gate(n)}, V_{Source}, V_{COM(n)}, and V_{CS} as observed in one of the plurality of pixels 40. Note in FIG. 5 that the liquid crystal applied voltage V (n) is positive in polarity. The waveform of the V_{COM(n)} changes (i) after the end of the selection period of the pixel 40 (i.e., after a falling edge of the V_{Gate}) and then (ii) immediately before the end of one horizontal scanning period (see a circled part of FIG. 5). Note here that the V_{COM(n)} is changed in the direction opposite to the positive polarity of the liquid crystal applied voltage V (n). Therefore, according to the principle described earlier, the overshoot drive is achieved.

Now, refer back to FIG. 4. The drive circuit 1 drives, after the end of the drive of pixels 40 corresponding to an n-th line, pixels 40 corresponding to a subsequent line (i.e. an [n+1]-th line). Specifically, the drive circuit 1 drives pixels 40 connected with the gate line 22 (n+1), after the end of an n-th horizontal scanning period but during an (n+1)-th horizontal scanning period.

The following discusses a procedure of such drive. The source signal generation section 13 reverses polarities of source signals that are to be supplied to the plurality of source lines 23. That is, the drive circuit 1 of the present embodiment carries out a line inversion driving so as to drive the display section 2. Then, the gate signal generation section 12 sends out, a short time after the reverse of the polarities of the source signals, a gate signal having a rectangular waveform to the gate line 22 (n+1). In the meantime, the liquid crystal applied voltage V₍ₙ₊₁₎ of pixels 40 connected with the gate line 22 (n+1) first rises in a positive direction, and thereafter is shifted dramatically in a negative direction. That is, the liquid crystal applied voltage V₍ₙ₊₁₎ here is negative in polarity.

Then, the COM signal generation section 15 changes, immediately before the end of the (n+1)-th horizontal scanning period, a voltage V_{COM(n+1)} of a COM line 25 (n+1) in such a way that the voltage V_{COM(n+1)} is increased in a positive direction, which is opposite to the negative polarity of the liquid crystal applied voltage V₍ₙ₊₁₎. Accordingly, the liquid crystal applied voltage V₍ₙ₊₁₎ is further shifted in the negative direction. In this way, the drive circuit 1 overshoot-drives the pixels 40 connected with the gate line 22 (n+1), each of which pixels 40 has a TFT 30 opened via the gate line 22 (n+1).

Similarly, the COM signal generation section changes a voltage V_{COM(n+2)} of a COM line 25 (n+2) in such a way that the V_{COM(n+2)} is reduced in a negative direction, which is opposite to a positive polarity of a liquid crystal applied voltage V₍ₙ₊₂₎. In this way, the drive circuit 1 overshoot-drives pixels 40 connected with a gate line 22 (n+2), each of which pixels 40 has a TFT 30 opened via the gate line 22 (n+2).

Similarly, the COM signal generation section changes a voltage V_{COM(n+3)} of a COM line 25 (n+3) in such a way that the V_{COM(n+3)} is increased in a positive direction, which is opposite to a negative polarity of a liquid crystal applied voltage V₍ₙ₊₃₎. In this way, the drive circuit 1 overshoot-drives pixels 40 connected with a gate line 22 (n+3), each of which pixels 40 has a TFT 30 opened via the gate line 22 (n+3).

Note here that the CS signal generation section 14 keeps sending out CS signals having a constant voltage. Therefore, the voltage V_{CS} of each of the plurality of CS lines 24 always keeps constant.

As so far described, the drive circuit 1 overshoot-drives the plurality of pixels 40 line-by-line while carrying out the line inversion driving. The COM drive provides an effect of the overshoot drive (this effect is hereinafter referred to as an overshoot-driving effect) greater than that of overshoot drive of the conventional art (i.e., the overshoot drive caused by CS drive). Accordingly, it is possible to cause liquid crystals in the display section 2 to respond more quickly, and thus possible to further improve display quality of still and moving images.

### (Theoretical Explanation of Overshoot-Driving Effect)

A voltage V_{Drain} to be applied to a drain of the TFT 30 of each of the plurality of pixels 40 is represented by the following Equation (1):

$$Δ {V}_{Drain} = \frac{1}{\sum C} ( {C}_{LC} Δ {V}_{COM} + {C}_{CS} Δ {V}_{CS} + {C}_{gd} Δ {V}_{Gate} + {C}_{sd} Δ {V}_{Source} ) \qquad ( 1 )$$

In Equation 1, the ΔV_{COM} represents an amount of change in the V_{COM} at the end of the selection period of each of the plurality of pixels 40. The ΔV_{CS} represents an amount of change in the V_{CS} at the end of the selection period of the pixel 40. The ΔV_{Gate} represents an amount of change in the V_{Gate} at the end of the selection period of the pixel 40. The ΔV_{Source} represents an amount of change in the V_{Source} at the end of the selection period of the pixel 40.

Further, in Equation 1, the C_{LC} represents a value of the liquid crystal capacitor 31. The C_{CS} represents a value of the storage capacitor 32. The C_{gd} represents a value of (i) a capacitance defined by a gate and a drain of the TFT 30 or (ii) a capacitance defined by a gate line and a drain in the pixel 40. The C_{sd} represents a value of a capacitance between a source and a drain in the pixel 40.

Furthermore, in Equation 1, the ΣC represents a total value of all the capacitances in the pixel 40. The value of the ΣC is calculated through the following Equation 2:

ΣC=C_{LC}+C_{CS}+C_{gd}+C_{sd}+ (2)

Generally, the value of the C_{LC} varies depending on the display state of the pixel 40. Therefore, the value of the V_{Drain} of the pixel 40, which is in transition, is different from that of the pixel 40, which is in a stable state. As used herein, “the pixel 40 in transition” means the pixel 40 whose state (i.e., transmittance of liquid crystal) has not yet reached a target state for a current frame. The pixel 40 is in transition for example in a case where a gray scale is different between in the current frame and in a previous frame. On the other hand, “the pixel 40 in a stable state” means the pixel 40 whose state (i.e., transmittance of liquid crystal) has already reached the target state for the current frame. The pixel 40 is in the stable state for example in a case where the gray scale remains constant throughout all frames.

Assume here that a capacitance of liquid crystals of the pixel 40, which is in the selected state, is C_{LC(A)}, whereas a capacitance of liquid crystals of the pixel 40, to which a target voltage is applied, is C_{LC(B)}. In a case of the pixel 40 in the stable state (state B), a voltage of the liquid crystals of the pixel 40 has already reached the target voltage. Therefore, the following Equation 3 is satisfied:

$$Δ {V}_{Drain} = \frac{1}{\sum {C}_{B}} ( {C}_{LC ( B )} Δ {V}_{COM} + {C}_{CS} Δ {V}_{CS} + {C}_{gd} Δ {V}_{Gate} + {C}_{sd} Δ {V}_{Source} ) \qquad ( 3 )$$

In Equation 3, the ΣC_{(B)} represents a total capacitance of the pixel 40 as observed when the target voltage is applied to the liquid crystals of the pixel 40.

On the other hand, in a case of the pixel 40 in transition (state A), the voltage of the liquid crystals has not yet reached the target voltage at a time when the pixel 40 is selected. Therefore, the following Equation 4 is satisfied:

$$Δ {V}_{Drain} = \frac{1}{\sum {C}_{A}} ( {C}_{LC ( A )} Δ {V}_{COM} + {C}_{CS} Δ {V}_{CS} + {C}_{gd} Δ {V}_{Gate} + {C}_{sd} Δ {V}_{Source} ) \qquad ( 4 )$$

In Equation 4, the ΣC (A) represents a total capacitance of the pixel 40 as observed before the target voltage is applied.

A difference between the V_{Drain} in Equation 3 and the V_{Drain} in Equation 4 causes the overshoot-driving effect on the liquid crystal applied voltage V.

The following description deals with a case where the display state of the pixel 40 is changed from a black state to a white state. That is, the state A is the black state, whereas the state B is the white state. In a case where a display mode of a liquid crystal display device is a normally black mode, the following Equation 5 is always satisfied:

C_{LC(B)}>C_{LC(A)} (5)

Since Equation 5 is satisfied, the following Equations 6 and 7 are also satisfied:

$$\begin{matrix}\frac{1}{\sum {C}_{B}} < \frac{1}{\sum {C}_{A}} & ( 6 ) \\ \frac{{C}_{LC ( B )}}{\sum {C}_{B}} > \frac{{C}_{LC ( A )}}{\sum {C}_{A}} & ( 7 )\end{matrix}$$

Assume here that the liquid crystal applied voltage V is positive in polarity. If a ΔV_{Drain(A)} is greater than a ΔV_{Drain(B)}, then the liquid crystal applied voltage applied to the pixel 40 in transition is higher than the liquid crystal applied voltage applied to the pixel 40 in the stable state. This causes the overshoot-driving effect. Note here that the ΔV_{Drain(A)} is a V_{Drain} of the pixel 40 in transition, whereas the ΔV_{Drain(B)} is the ΔV_{Drain} of the pixel 40 in the stable state. A difference between the ΔV_{Drain(A)} and the ΔV_{Drain(B)} is represented by the following Equation 8:

$$\begin{matrix}δΔ {V}_{Drain ( A ⇒ B )} = Δ {V}_{Drain ( A )} - Δ {V}_{Drain ( B )} \\ = ( \frac{{C}_{LC ( A )}}{\sum {C}_{A}} - \frac{{C}_{LC ( B )}}{\sum {C}_{B}} ) Δ {V}_{COM} + ( \frac{1}{\sum {C}_{A}} - \frac{1}{\sum {C}_{B}} ) \\ ( {C}_{CS} Δ {V}_{CS} + {C}_{gd} Δ {V}_{Gate} + {C}_{sd} Δ {V}_{Source} )\end{matrix} \qquad ( 8 )$$

According to Equation 8, the overshoot-driving effect is attained in a case where ΔV_{COM}<0, ΔV_{CS}>0, ΔV_{Gate}>0, and V_{Source}>0. Among those, the most important factor contributing to the overshoot-driving effect is the ΔV_{COM}. In other words, the amount of the change in the voltage V_{COM} (i.e., ΔV_{COM}) is the most important factor contributing to the overshoot-driving effect, provided that the amount of the change in the voltage is identical among those described above.

On the other hand, if the liquid crystal applied voltage V is negative in polarity, the overshoot-driving effect is attained in a case where ΔV_{COM}>0, ΔV_{CS}<0, ΔV_{Gate}<0, and V_{Source}<0. Also in this case, the most important factor contributing to the overshoot-driving effect among those is the ΔV_{COM}.

As so far described, the overshoot-driving effect in the display section 2 is exerted in a case where:

the V_{COM} is changed in a direction opposite to the polarity of the liquid crystal applied voltage V;

the V_{CS} is changed in a same direction as the polarity of the liquid crystal applied voltage V;

the V_{Gate} is changed in a same direction as the polarity of the liquid crystal applied voltage V; and

the V_{Source} is changed in a same direction as the polarity of the liquid crystal applied voltage V.

It should be noted that a relation between the above voltage changes and the overshoot-driving effect also applies to a liquid crystal display device of a normally white mode.

### (Explanation for Overshoot Drive)

The following description discusses the overshoot-driving effect in the display section 2, by giving an example that a state of each of the plurality of pixels 40 is changed from the black state to the white state. In the following example, the state A is the black state, whereas the state B is the white state. Further, the liquid crystal applied voltage V is positive in polarity. For the sake of easy explanation, the following example deals with only an effect of the change in a V_{COM(n)}. The effect of the change in the V_{COM(n)} alone is represented by the following Equation 9:

$$Δ {V}_{Drain} = \frac{1}{\sum {C}_{A}} ( {C}_{LC ( A )} Δ {V}_{COM} ) \qquad ( 9 )$$

In the following, a comparison is carried out between a case of the pixel 40 in transition and a case of the pixel 40 in the stable state. In this example, “the pixel 40 in transition” means the pixel 40 which is in the black state in the previous frame (state A) and is in the white state in the current frame (state B). On the other hand, “the pixel 40 in the stable state” means the pixel 40 which is in the white state both in the previous frame (state A) and the current frame (state B). Since the pixel 40 in transition and the pixel 40 in the stable state are defined as above, the following Equation 10 is satisfied:

$$\begin{matrix}δΔ {V}_{Drain} = Δ {V}_{Drain ( A ⇒ B )} - Δ {V}_{Drain ( B ⇒ A )} \\ = \frac{1}{\sum {C}_{A}} ( {C}_{LC ( A )} Δ {V}_{COM} ) - \frac{1}{\sum {C}_{B}} ( {C}_{LC ( B )} Δ {V}_{COM} ) \\ = \frac{( {C}_{LC ( A )} - {C}_{LC ( B )} ) ( {C}_{CS} + {C}_{gd} + {C}_{sd} + … )}{( \sum {C}_{A} ) ( \sum {C}_{B} )} Δ {V}_{COM}\end{matrix} \qquad ( 10 )$$

In Equation 10, C_{LC(A)}<C_{LC(B)}, as well as V_{COM}<0. Therefore, δΔV_{Drain}>0. That is, the V_{Drain} is greater in the pixel 40 in transition than in the pixel 40 in the stable state. Note here that liquid crystals of the pixel 40 receive a positive voltage. Accordingly, the COM drive provides the liquid crystal applied voltage V higher than that of other drive. This is the overshoot-driving effect.

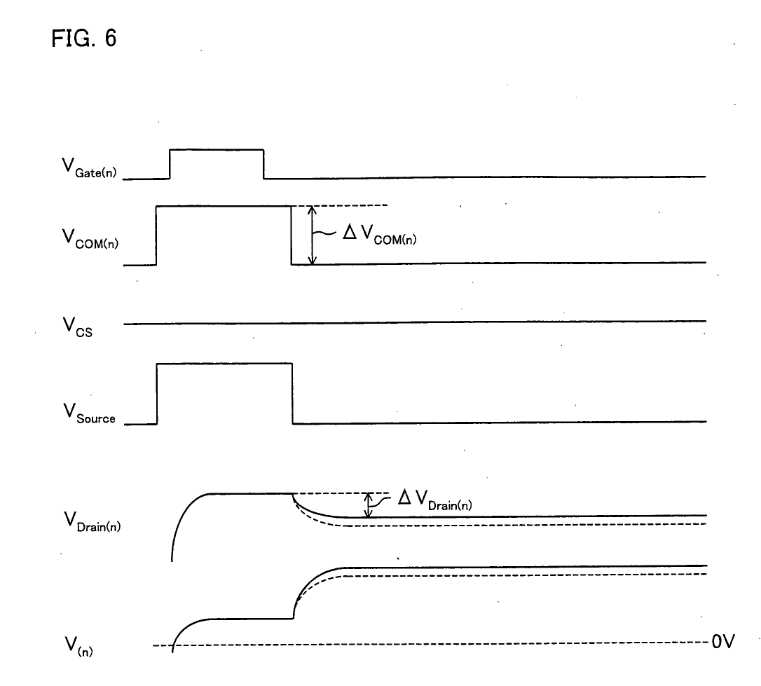

Specific descriptions therefor are given with reference to FIG. 6. FIG. 6 illustrates the overshoot-driving effect of the present invention. In FIG. 6, a waveform of a drain voltage V_{Drain(n)} indicated by a solid line is for the pixel 40 in transition, whereas a waveform of the drain voltage V_{Drain(n)} indicated by a dotted line is for the pixel 40 in the stable state. Further, a waveform of a liquid crystal applied voltage V (n) indicated by a solid line is for the pixel 40 in transition, whereas a waveform of the liquid crystal applied voltage V (n) indicated by a dotted line is for the pixel 40 in the stable state. As illustrated in FIG. 6, the ΔV_{Drain(n)} for the pixel 40 in transition is greater in the negative direction than the ΔV_{Drain(n)} for the pixel 40 in the stable state. Accordingly, the V (n) for the pixel 40 in transition has a greater overshoot-driving effect than that of the V (n) for the pixel 40 in the stable state.

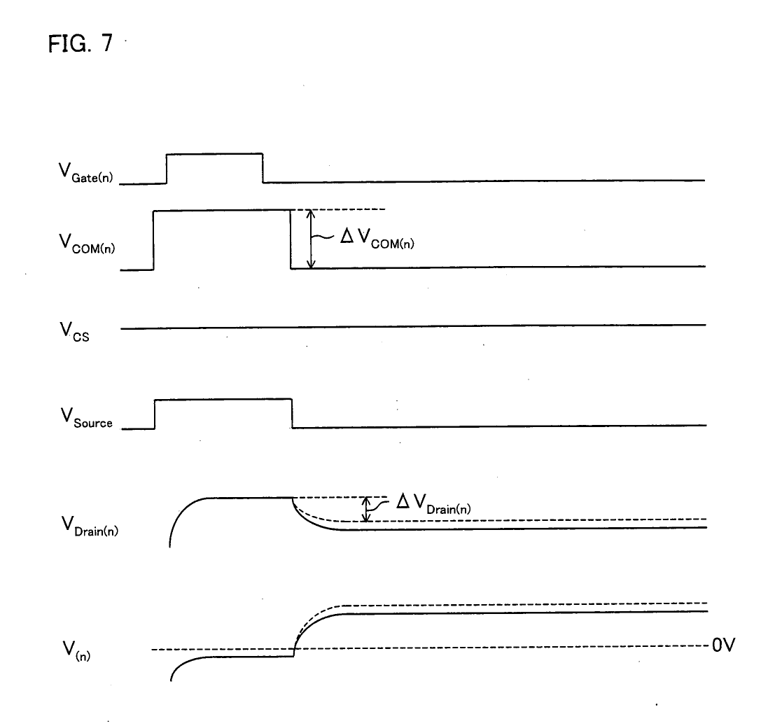

Next, an example opposite to that of FIG. 6 is described below with reference to FIG. 7. FIG. 7 illustrates another example of the overshoot-driving effect of the present invention. In FIG. 7, a waveform of the drain voltage V_{Drain(n)} indicated by a solid line is for the pixel 40 in transition, whereas a waveform of the drain voltage V_{Drain(n)} indicated by a dotted line is for the pixel 40 in the stable state. Further, a waveform of the liquid crystal applied voltage V (n) indicated by a solid line is for the pixel 40 in transition, whereas a waveform of the liquid crystal applied voltage V (n) indicated by a dotted line is for the pixel 40 in the stable state. In this example of FIG. 7, the state of the pixel 40 changes from the white state to the black state while the pixel 40 is in transition, whereas the state changes from the black state to the black state while the pixel 40 is in the stable state. That is, the state A is the white state, whereas the state B is the black state. In this case, the following Equation 11 is satisfied:

$$δΔ {V}_{Drain} = \frac{( {C}_{LC ( B )} - {C}_{LC ( A )} ) ( {C}_{CS} + {C}_{gd} + {C}_{sd} + … )}{( \sum {C}_{A} ) ( \sum {C}_{B} )} Δ {V}_{COM} \qquad ( 11 )$$

In Equation 11, C_{LC(B)}<C_{LC(A)}, as well as V_{COM}<0. Therefore, δΔV_{Drain}<0. That is, the V_{Drain} for the pixel 40 in transition is less than the V_{Drain} for the pixel 40 in the stable state. Note here that liquid crystals of the pixel 40 receive a positive voltage. Accordingly, the value of the liquid crystal applied voltage is further reduced. This is the overshoot-driving effect.

### (Exemplary Quantitative Determination of Overshooting-Driving Effect)

The following description discusses an exemplary quantitative determination of the overshoot-driving effect of a case where the state of the pixel 40 is changed from the black state to the white state. First, assume that the state A is the black state, whereas the state B is the white state. In this case, the earlier-described Equation 8 is satisfied. Next, further assume that the variables in Equation 8 take the following values:

C_{LC(A)}=100 fF;

C_{LC(B)}=300 fF;

C_{CS}=200 fF;

C_{gd}=10 fF;

C_{sd}=10 fF;

ΣC (A)=320 fF;

ΣC (B)=520 fF;

ΔV_{COM}=−5V;

ΔV_{CS}=5V;

ΔV_{Gate}=5V; and

ΔV_{Source}=5V.

Under such circumstances, if the state of the pixel 40 is changed from the state A to the state B, each electrode receives the following effect of the change in the voltage:

V_{COM}=1.3V;

V_{CS}=1.2V;

V_{Gate}=0.1V; and

V_{Source}=0.1V.

### (Advantage of COM Drive Over CS Drive)

The COM drive of the display section 2 in accordance with the present invention provides an overshoot-driving effect greater than CS drive of a display section of a conventional art. The reason therefor is described below. As used herein, the CS drive is such that, after the end of the selection period of each of the plurality of pixels 40, a V_{CS} is changed in a same direction as a polarity of the liquid crystal applied voltage.

As described earlier, the overshoot driving-effect is represented by Equation 8, in a case where the state of the pixel 40 is changed from the state A to the state B. Assume here that a liquid crystal display device is of a normally black type. In this case, a liquid crystal applied voltage C_{LC} of a case where the pixel 40 has a higher gray scale level is always greater than that of a case where the pixel 40 has a lower gray scale level. Accordingly, in a case where (i) the liquid crystals of the pixel 40 receive a positive voltage and then (ii) the state of the pixel 40 is changed from the black state to the white state, the resulting overshoot-driving effect becomes greater as the δΣV_{Drain} becomes larger.

According to Equation 8, the following Equation 12 is satisfied in a case where the display section 2 is driven by COM drive:

$$\begin{matrix}δΔ {V}_{Drain ( A ⇒ B )} = ( \frac{{C}_{LC ( A )}}{\sum {C}_{A}} - \frac{{C}_{LC ( B )}}{\sum {C}_{B}} ) Δ {V}_{COM} \\ = \frac{( {C}_{CS} + {C}_{gd} + {C}_{sd} ) ( {C}_{LC ( A )} - {C}_{LC ( B )} )}{( \sum {C}_{A} ) ( \sum {C}_{B} )} Δ {V}_{COM}\end{matrix} \qquad ( 12 )$$

On the other hand, according to Equation 12, the following Equation 13 is satisfied in a case where the display section 2 is driven not by COM drive but by CS drive:

$$\begin{matrix}δΔ {V}_{Drain ( A ⇒ B )} = ( \frac{1}{\sum {C}_{A}} - \frac{1}{\sum {C}_{B}} ) {C}_{CS} Δ {V}_{CS} \\ = \frac{{C}_{CS} ( {C}_{LC ( B )} - {C}_{LC ( A )} )}{( \sum {C}_{A} ) ( \sum {C}_{B} )} Δ {V}_{CS}\end{matrix} \qquad ( 13 )$$

According to Equations 12 and 13, the δΣV_{Drain} of a case of the COM drive has a value greater, by an amount resulting from the C_{gd} and C_{sd}, than that of the δΣV_{Drain} of a case of the CS drive. This demonstrates that the COM drive provides the overshoot-driving effect greater than that of the CS drive, provided that each of the ΔV_{COM} and the ΔV_{CS} has an identical value both in the cases of the COM drive and the CS drive. Further, the COM drive provides the overshoot-driving effect greater than that of the CS drive also in cases where (i) the liquid crystals of the pixel 40 receive a negative voltage and (ii) the state of the pixel 40 is changed from the white state to the black state.

### SUMMARY

As so far described, the present invention provides a drive circuit 1 capable of overshoot-driving liquid crystals sufficiently without requiring additional members which take up much space. Further, the present invention provides a liquid crystal module 50 including (i) the drive circuit 1 and (ii) a display section 2 driven by the drive circuit 1. Furthermore, the present invention provides a liquid crystal display device including the liquid crystal module 50.

### (Simultaneous Use of COM Drive and CS Drive)

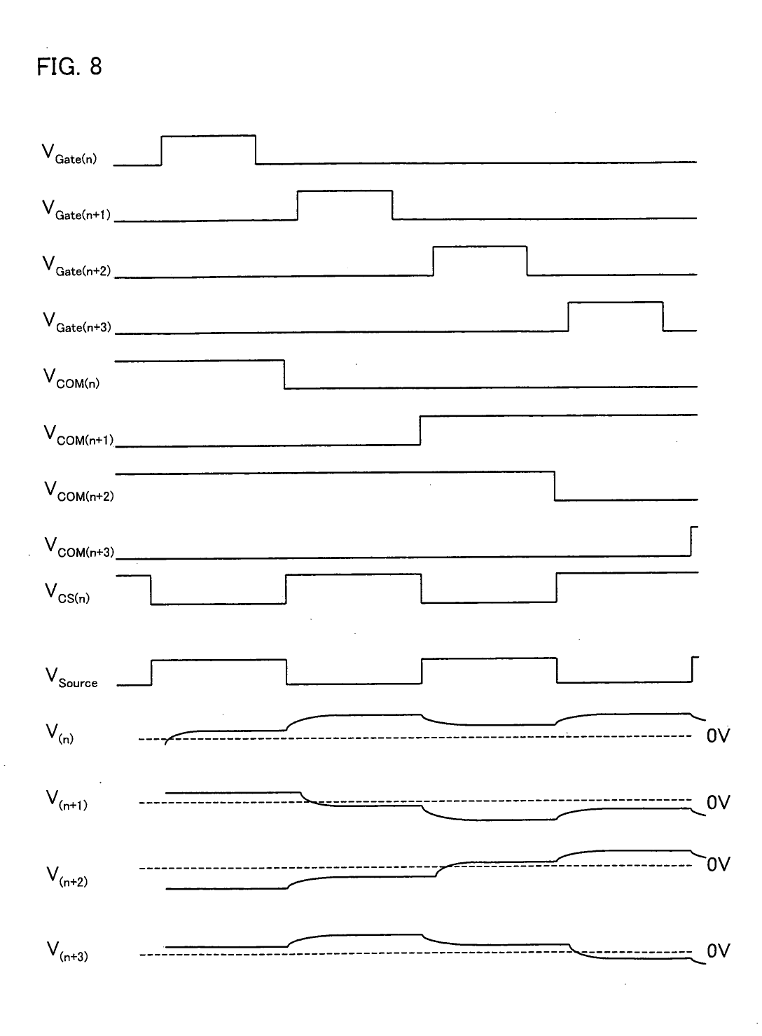

The drive circuit 1 can carry out, as well as the COM drive described above, the CS drive simultaneously with the COM drive. FIG. 8 illustrates waveforms at various points in the display section 2 as observed in a case where the drive circuit 1 carries out the CS drive as well as the COM drive. Specifically, FIG. 8 illustrates waveforms of voltages (electric potentials) at various points in each of the plurality of pixels 40 as observed in the case where the drive circuit 1 carries out the CS drive as well as the COM drive. The waveforms of the voltages (i) V_{Gate}, (ii) V_{Source}, and (iii) V_{COM} of each of the plurality of COM lines 25 are same as those illustrated in FIG. 4. That is, the drive circuit 1 drives the display section 2 by a line inversion driving. On the other hand, the waveform of the V_{CS} is an AC waveform, which is different from the DC waveform illustrated in FIG. 4. That is, the waveform of the V_{CS} of FIG. 8 is not constant, and varies for every horizontal scanning period.

### (Overshoot Drive)

According to FIG. 8, the drive circuit 1 carries out the COM drive and the SC drive after the end of the selection period of the pixel 40. Specifically, the COM signal generation section 15 changes the V_{COM(n)} in a direction opposite to a polarity of a target level of the V (n). According to FIG. 8, a timing of the change in the V_{COM(n)} is same as the timing of the change in the V_{Source} (note however that these timings do not necessarily have to be identical). Further, the CS signal generation section 14 changes the V_{CS} in a same direction as the polarity of the target level of the V (n). According to FIG. 8, a timing of the change in the V_{CS} is same as the timing of the change in the V_{Source} (note however that these timings do not necessarily have to be identical).

As a result of these changes, the V (n) here is further shifted in a positive direction. Note here that an amount by which the V (n) is shifted in the positive direction exhibits a characteristic same as that observed when the overshoot drive of the display section 2 is carried out. That is, when a display state of the pixel 40 changes from a state where the liquid crystal applied voltage is small to a state where the liquid crystal applied voltage is large, the following occurs. If the liquid crystal applied voltage is positive in polarity, then the liquid crystal applied voltage is further shifted in the positive direction. On the other hand, if the liquid crystal applied voltage is negative in polarity, then the liquid crystal applied voltage is further shifted in the negative direction. In this way, the overshoot-driving effect is attained. The overshoot-driving effect here is a sum of (i) the overshoot-driving effect, caused by the COM drive, which is described with reference to FIG. 4 and (ii) an overshoot-driving effect caused by the CS drive in accordance with the same principle as in the COM drive of FIG. 4. As such, the pixel 40 receives a greater overshoot-driving effect. That is, response speed of liquid crystals of the pixel 40 is more improved. Note however that, as to the change in the voltage of each of the plurality of CS lines 24, the change in an effective value of the voltage in one vertical period affects the above effect. In the present embodiment, the plurality of CS lines 24 are AC-driven so that polarities of voltages thereof are reversed for every horizontal scanning period. Therefore, the effective value of the ΔV_{CS} is less than the ΔV_{CS}. As a result, the effect of the CS drive also becomes small.

### Embodiment 2

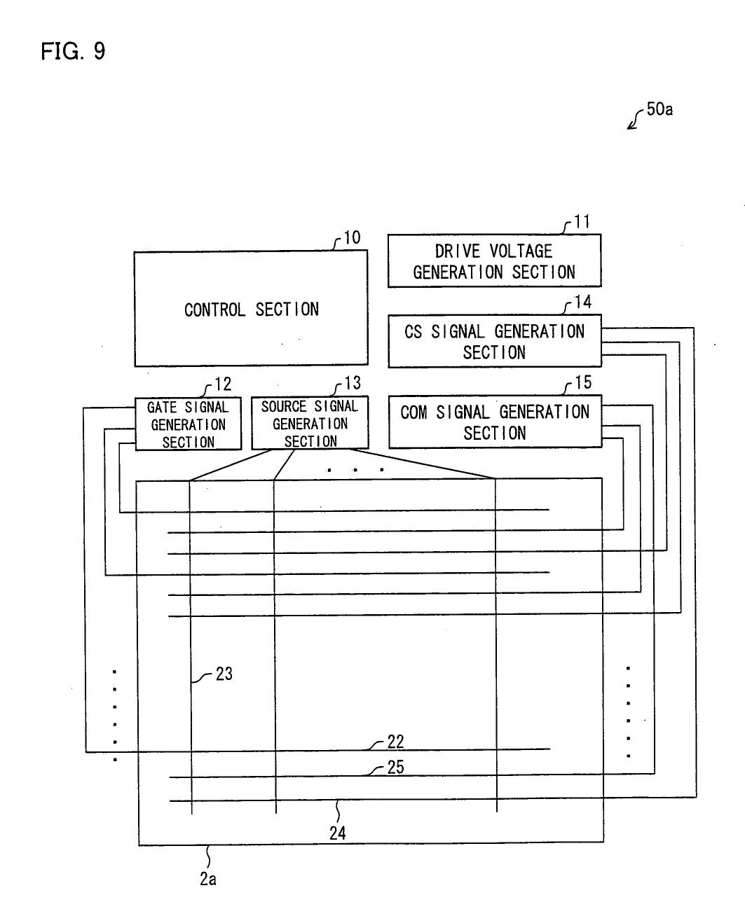

A second embodiment in accordance with the present invention is described below with reference to FIGS. 9 through 12. Note in the present embodiment that members same as those described in Embodiment 1 are respectively provided with reference numerals same as those described in Embodiment 1, and detailed descriptions therefor are omitted here.

### (Configuration of Liquid Crystal Module 50)

FIG. 9 illustrates a configuration of a main part of a liquid crystal module 50a in accordance with the present embodiment. As illustrated in FIG. 9, the liquid crystal module 50a includes a drive circuit 1 and a display section 2a. The liquid crystal module 50 serves as a constituent part of a liquid crystal display device (not illustrated).

The display section 2a of the present embodiment has a configuration different from that of the display section 2 of Embodiment 1. The difference between these configurations is how the plurality of CS lines 24 are arranged. In the display section 2a, the plurality of CS lines 24 correspond to the respective plurality of gate lines 22 and are electrically insulated from one another, in the same manner as the plurality of COM lines 25. This makes it possible for the CS signal generation section 14 to individually drive each of the plurality of CS lines 24.

(Equivalent Circuit for Liquid Crystals of Display Section 2a)

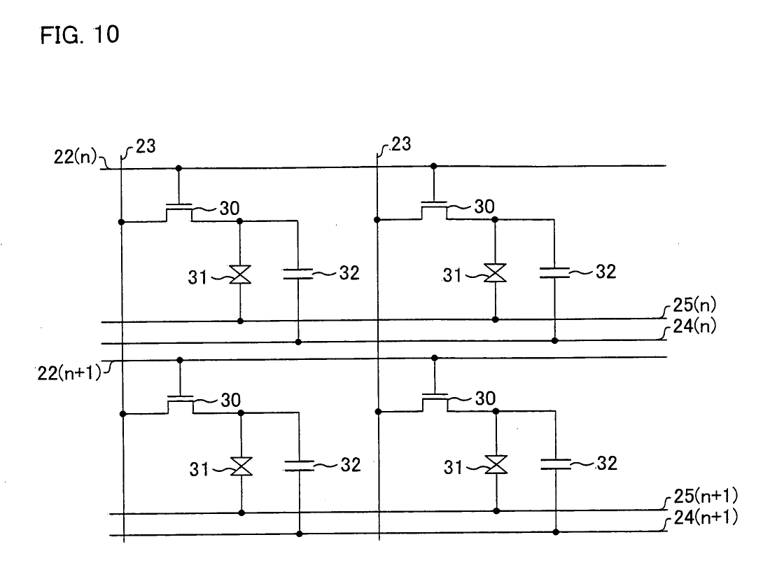

FIG. 10 illustrates an equivalent circuit, for liquid crystals, of the display section 2a. As illustrated in FIG. 10, the display section 2a is configured such that the plurality of CS lines 24 correspond to the respective plurality of gate lines 22, and are electrically insulated from one another. For example, pixels 40 between a gate line 22 (n) and a gate line 22 (n+1) are provided with a CS line 24 (n). According to this configuration, the CS signal generation section 14 sends out an individual CS signal to each of the plurality of CS lines 24. As such, it is possible to individually and independently change a voltage of each of the plurality of CS lines 24.

Note here that the configuration shown in FIG. 10 is merely an example, and therefore the present invention is not limited to the configuration. For example, the plurality of COM lines 25 can be a single electrode shared by all the plurality of gate lines 22. Further, voltage input ports of the plurality of CS lines 24 and voltage input ports of the plurality of COM lines 25 can be provided on the same side as those of the plurality of gate lines 22.

### (Simultaneous Use of COM Drive and CS Drive)

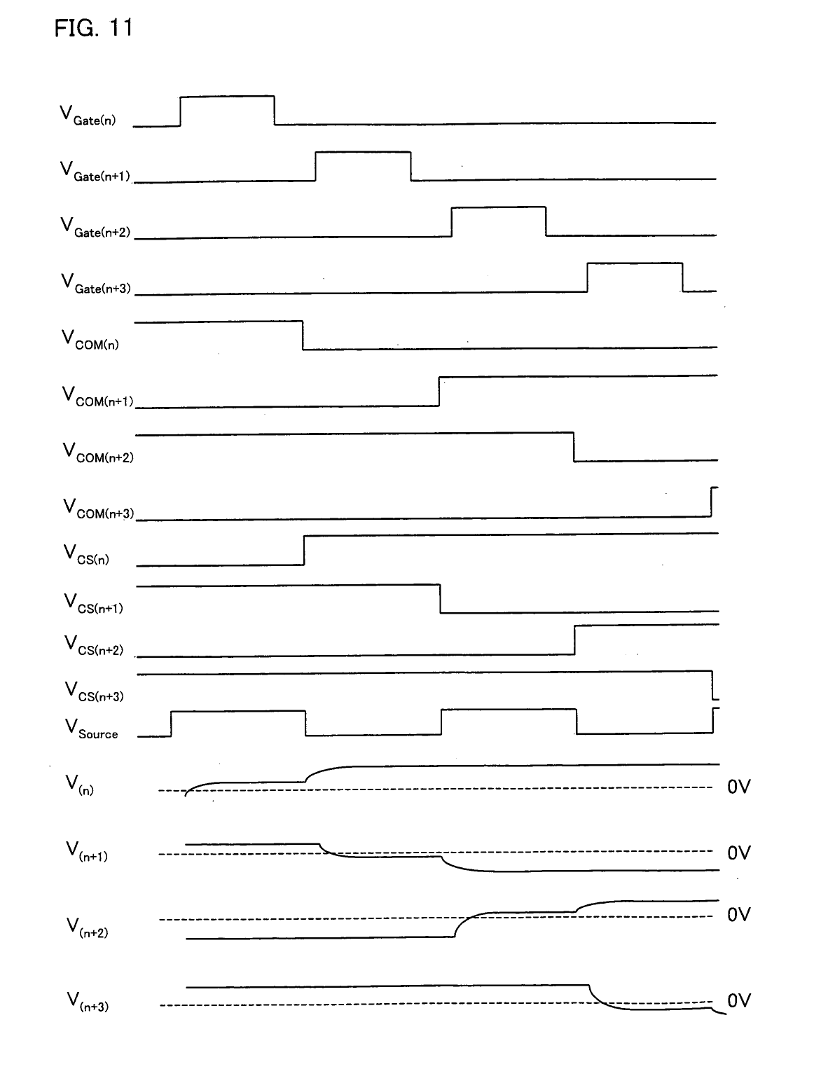

The drive circuit 1 carries out, as well as the COM drive described above, the CS drive simultaneously with the COM drive. This further improves the overshoot-driving effect compared to that of Embodiment 1. FIG. 11 illustrates waveforms at various points in the display section 2a. Specifically, FIG. 11 illustrates waveforms of voltages (electric potentials) at various points in each of the plurality of pixels 40 as observed when the drive circuit 1 carries out the CS drive as well as the COM drive. In FIG. 11, the waveforms of the voltages (i) V_{Gate}, (ii) V_{Source}, and (iii) V_{COM} of each of the plurality of COM lines 25 are same as those shown in FIG. 4. On the other hand, the waveform of the V_{CS} is different from that shown in FIG. 4 and FIG. 8. The waveform of the V_{CS} in FIG. 11 is such that a polarity thereof is reversed after the end of the selection period of the pixel 40.

### (Overshoot Drive)

According to FIG. 11, the drive circuit 1 carries out the COM drive and the CS drive after the end of the selection period of the pixel 40. Specifically, the COM signal generation section 15 changes the V_{COM(n)} in a direction opposite to a polarity of the V (n). According to FIG. 11, a timing of the change in the V_{COM(n)} is same as the timing of the change in the V_{Source} (note however that these timings do not necessarily have to be identical). Further, the CS signal generation section 14 changes the V_{CS(n)} in a same direction as the polarity of the V (n). According to FIG. 11, a timing of the change in the V_{CS(n)} is same as the timing of the change in the V_{Source} (note however that these timings do not necessarily have to be identical).

As a result of these changes, the V (n) here is further shifted in a positive direction. Note here that an amount by which the V (n) is shifted in the positive direction exhibits a characteristic same as that observed when the overshoot drive of the display section 2a is carried out. That is, when a display state of the pixel 40 changes from a state where the liquid crystal applied voltage is small to a state where the liquid crystal applied voltage is large, the following occurs. If the liquid crystal applied voltage is positive in polarity, then the liquid crystal applied voltage is further shifted in the positive direction. On the other hand, if the liquid crystal applied voltage is negative in polarity, then the liquid crystal applied voltage is further shifted in the negative direction. In this way, the overshoot-driving effect is attained. The overshoot-driving effect here is a sum of (i) the overshoot-driving effect caused by the COM drive and (ii) the overshoot-driving effect caused by the CS drive in accordance with the same principle as in the COM drive. As such, the pixel 40 receives a greater overshoot-driving effect. That is, response speed of liquid crystals of the pixel 40 is more improved. Further, the V_{CS(n)} does not return to an initial electric potential for next one vertical scanning period. Therefore, the effective value of the ΔV_{CS} in each vertical scanning period is same as the ΔV_{CS}. As such, the overshoot-driving effect attained is greater than that of Embodiment 1.

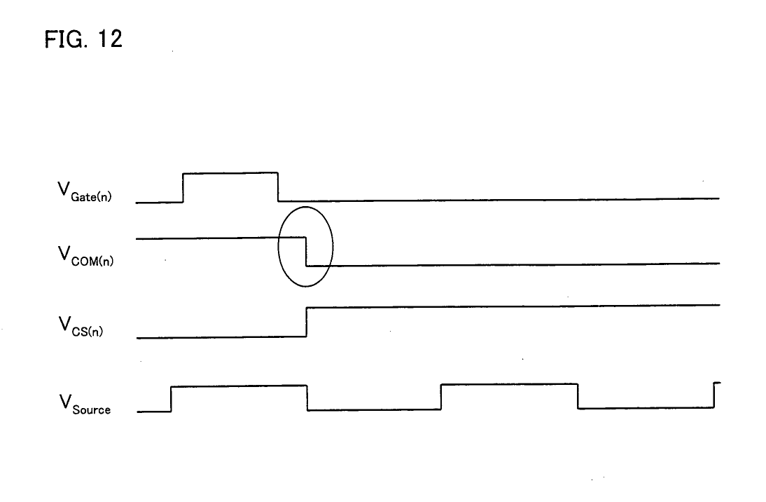

FIG. 12 selectively illustrates, among the waveforms shown in FIG. 11, waveforms of voltages in each of pixels 40 connected with one of the plurality of gate lines 22 (i.e., a gate line 22 [n]). Specifically, FIG. 12 illustrates waveforms of V_{Gate(n)}, V_{Source}, V_{COM(n)} and V_{CS(n)} in one of the pixels 40 connected with the gate line 22 (n). In this example of FIG. 12, the liquid crystal applied voltage V (n) is positive in polarity.

In FIG. 12, the waveform of the V_{COM(n)} changes after the end of the selected state of the pixel 40 (i.e., after a falling edge of the V_{Gate}) but immediately before the end of one horizontal scanning period (see a circled part of FIG. 12). Note here that the V_{COM(n)} is changed in a direction opposite to the positive polarity of the liquid crystal applied voltage V (n). Further, the waveform of the V_{CS(n)} changes after the end of the selected period of the pixel 40 (i.e., after a falling edge of the V_{Gate}) but immediately before the end of one horizontal scanning period. Note here that the V_{CS(n)} is changed in a same direction as the positive polarity of the liquid crystal applied voltage V (n).

### Embodiment 3

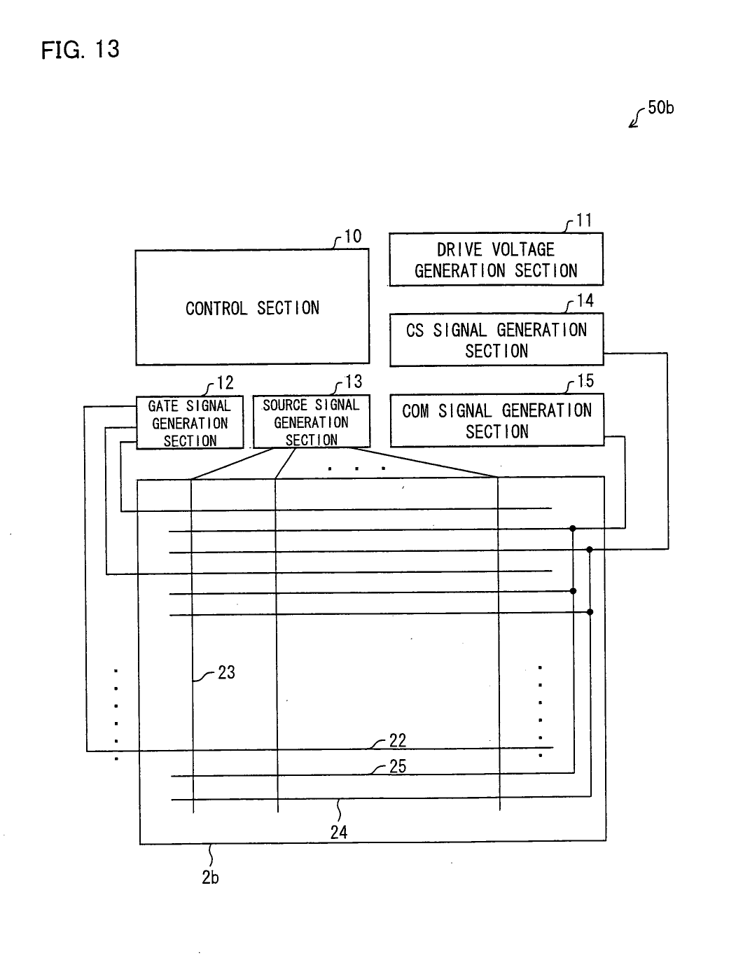

A third embodiment in accordance with the present invention is described below with reference to FIGS. 13 through 16. Note in the present embodiment that members same as those described in Embodiment 1 are respectively provided with reference numerals same as those described in Embodiment 1, and detailed descriptions therefor are omitted here.

### (Configuration of Liquid Crystal Module 50)

FIG. 13 illustrates a configuration of a main part of a liquid crystal module 50b in accordance with the present embodiment. As illustrated in FIG. 13, the liquid crystal module 50b includes a drive circuit 1 and a display section 2b. The liquid crystal module 50 serves as a constituent part of a liquid crystal display device (not illustrated).

The display section 2b of the present embodiment has a configuration different from that of the display section 2 of Embodiment 1. The difference between these configurations is how the plurality of COM lines 25 are arranged. In the display section 2b of the present embodiment, the plurality of COM lines 25 are provided so that their voltages are identical over the whole display section 2b. That is, the plurality of COM lines 25 are short-circuited one another. According to this configuration, the COM signal generation section changes the voltages of the plurality of COM lines 25 not individually, but in a uniform manner (that is, the voltages of all the plurality of COM lines 25 are changed at once).

Note here that the plurality of COM lines 25 can be a single flat electrode. This makes the configuration of the display section 2b of the present embodiment simpler than those of Embodiments 1 and 2. As such, it is possible to simplify a manufacturing process.

(Equivalent Circuit for Liquid Crystals of Display Section 2b)

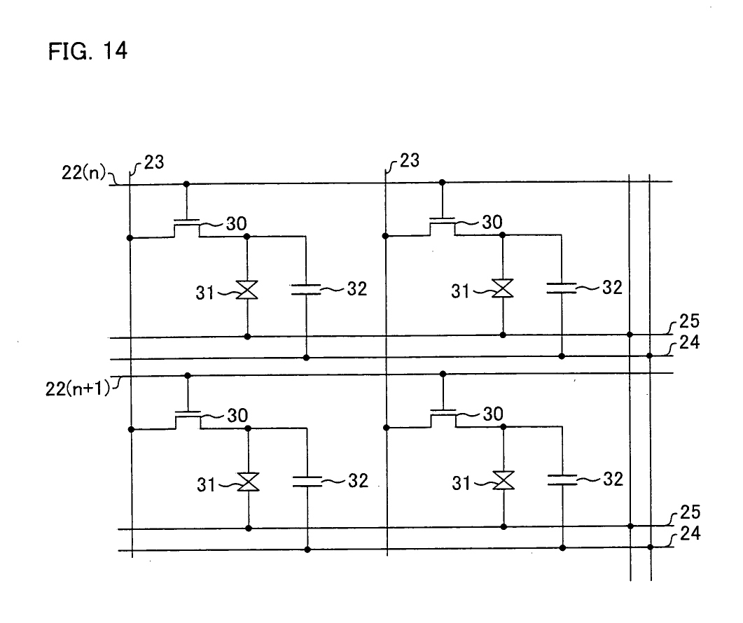

FIG. 14 illustrates an equivalent circuit, for liquid crystals, of the display section 2b. As illustrated in FIG. 14, the display section 2b is configured such that the plurality of COM lines 25 correspond to respective plurality of gate lines 22, but are short-circuited one another. Therefore, the COM signal generation section 15 sends out an identical COM signal to all the plurality of COM lines 25 at once. Similarly, the plurality of CS lines 24 correspond to the respective plurality of gate lines 22, but are short-circuited one another. Accordingly, the CS signal generation section 14 sends out an identical CS signal to all the plurality of CS lines 24 at once.

Note here that the configuration shown in FIG. 14 is merely an example, and therefore the present invention is not limited to the configuration. For example, voltage input ports of the plurality of CS lines 24 and voltage input ports of the plurality of COM lines 25 can be provided on the same side as those of the plurality of gate lines 22.

### (Overshoot Drive Caused by COM Drive)

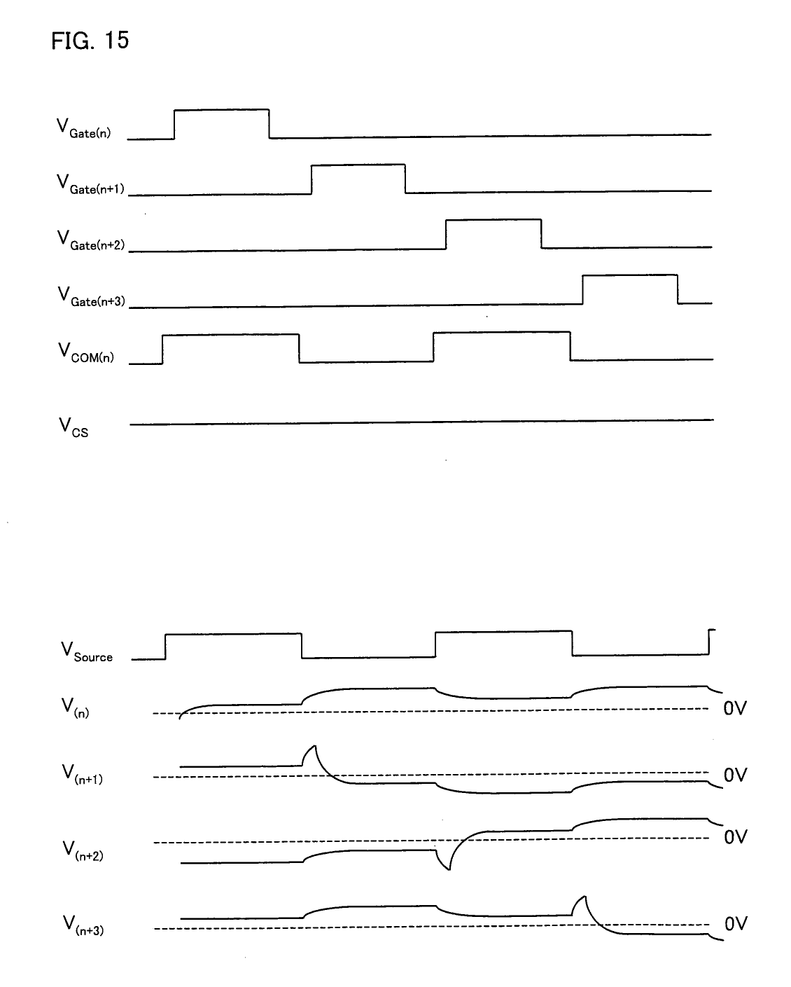

FIG. 15 illustrates waveforms at various points in the display section 2b as observed in a case where the drive circuit 1 of the present embodiment carries out the COM drive. Specifically, FIG. 15 illustrates waveforms of voltages (electric potentials) at various points in each of the plurality of pixels 40 as observed in a case where the drive circuit 1 carries out the COM drive. The waveforms of V_{Gate}, V_{Source}, V_{CS}, and V_{COM} of FIG. 15 are same as those shown in FIG. 4.

According to FIG. 15, the COM signal generation section 15 changes the V_{COM} in a direction opposite to a polarity of the V (n), after the end of a selection period of the pixel 40 but during an n-th horizontal scanning period. According to FIG. 15, a timing of the change in the V_{COM} is same as the timing of the change in the V_{Source} (note however that these timings do not necessarily have to be identical). As a result of the change in the V_{COM}, the V (n) here is further shifted in the positive direction. Accordingly, liquid crystals in the pixel 40 receive the voltage V (n) having a greater value. In this way, the pixel 40 is overshoot-driven.

### (Overshoot Drive Caused by COM Drive and CS Drive)

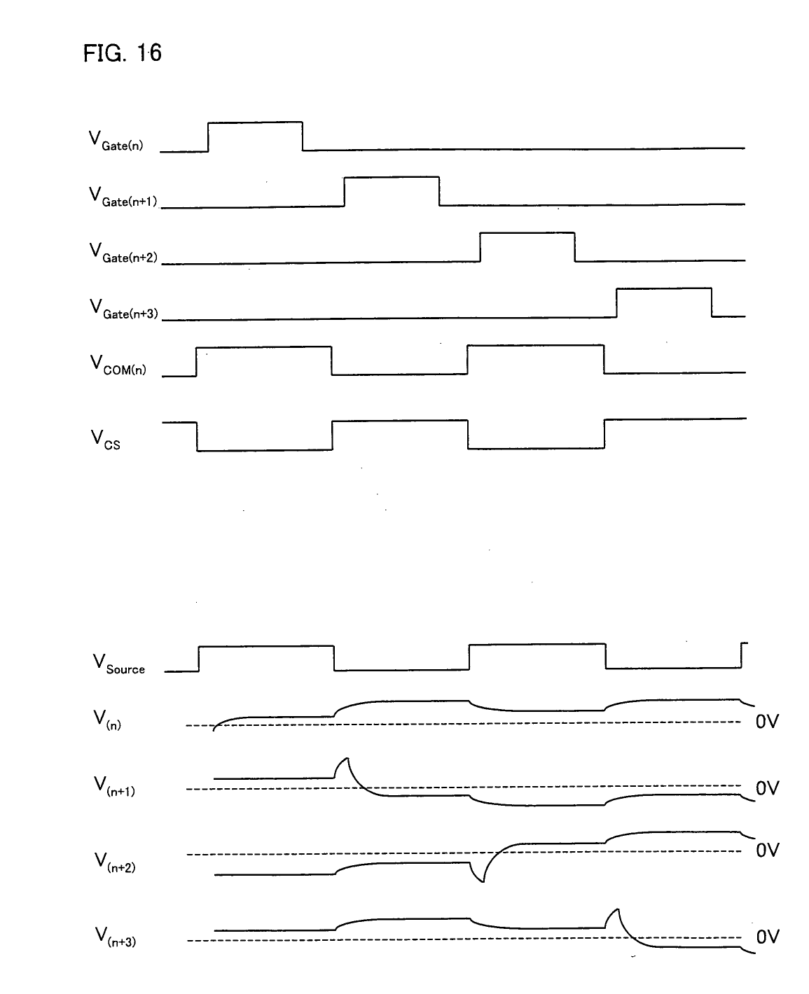

FIG. 16 illustrates waveforms at various points in each of the plurality of pixels 40 as observed in a case where the drive circuit 1 carries out the COM drive and the CS drive. Specifically, FIG. 16 illustrates waveforms of voltages (electric potentials) at various points in each of the plurality of pixels 40 as observed in a case where the drive circuit 1 carries out the COM drive and the CS drive. The waveforms of V_{Gate}, V_{Source}, and V_{COM} shown in FIG. 16 are same as those shown in FIG. 15. On the other hand, the waveform of the V_{CS} is an AC waveform, which is different from the DC waveform shown in FIG. 15. That is, the waveform of the V_{CS} of FIG. 16 is not constant, and varies for every horizontal scanning period.

According to FIG. 16, the drive circuit 1 carries out the COM drive and the SC drive after the end of the selection period of the pixel 40. Specifically, the COM signal generation section 15 changes the V_{COM(n)} in a direction opposite to a polarity of the V (n). According to FIG. 16, a timing of the change in the V_{COM(n)} is same as the timing of the change in the V_{Source} (note however that these timings do not necessarily have to be identical). Further, the CS signal generation section 14 changes the V_{CS(n)} in a same direction as the polarity of the V (n). According to FIG. 8, a timing of the change in the V_{CS(n)} is same as the timing of the change in the V_{Source} (note however that these timings do not necessarily have to be identical).

As a result of these changes, the V (n) here is further shifted in the positive direction. Note here that an amount by which the V (n) is shifted in the positive direction exhibits a characteristic same as that observed when the overshoot drive of the display section 2b is carried out. That is, when a display state of the pixel 40 changes from a state where the liquid crystal applied voltage is small to a state where the liquid crystal applied voltage is large, the following occurs. If the liquid crystal applied voltage is positive in polarity, then the liquid crystal applied voltage is further shifted in the positive direction. On the other hand, if the liquid crystal applied voltage is negative in polarity, then the liquid crystal applied voltage is further shifted in the negative direction. In this way, the overshoot-driving effect is attained. The overshoot-driving effect here is a sum of (i) the overshoot-driving effect caused by the COM drive and (ii) the overshoot-driving effect caused by the CS drive in accordance with the same principle as in the COM drive. As such, the pixel 40 receives a greater overshoot-driving effect. That is, response speed of liquid crystals of the pixel 40 is more improved. Note however that, as to the change in the voltage of each of the plurality of CS lines 24, the change in an effective value of the voltage in one vertical period affects the above effect. In the present embodiment, the V_{COM} and the V_{CS} are AC-driven in such a way that polarities thereof are reversed for every horizontal scanning period. Therefore, the effective value of the ΔV_{COM} is less than the ΔV_{COM}, and the effective value of the ΔV_{CS} is less than the ΔV_{CS}. As a result, the effects of the COM drive and the CS drive also become small.

### Embodiment 4

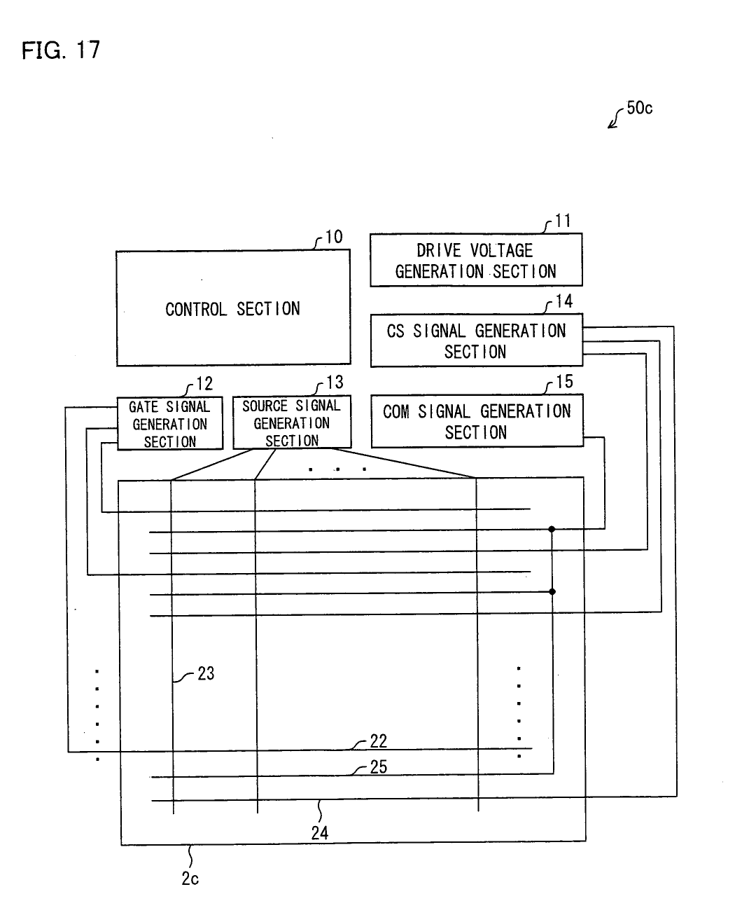

A fourth embodiment in accordance with the present invention is described below with reference to FIGS. 17 through 19. Note in the present embodiment that members same as those described in Embodiments 1 through 3 are respectively provided with reference numerals same as those described in Embodiments 1 through 3, and detailed descriptions therefor are omitted here.

### (Configuration of Liquid Crystal Module 50)

FIG. 17 illustrates a configuration of a main part of a liquid crystal module 50c in accordance with the present embodiment. As illustrated in FIG. 17, the liquid crystal module 50c includes a drive circuit 1 and a display section 2c. The liquid crystal module 50 serves as a constituent part of a liquid crystal display device (not illustrated).

The display section 2c of the present embodiment has a configuration different from that of the display section 2b of Embodiment 3. The difference between these configurations is how the plurality of CS lines 24 are arranged. In the display section 2, the plurality of CS lines 24 correspond to the respective plurality of gate lines 22, and are electrically insulated from one another. This makes it possible for the CS signal generation section 14 to individually drive each of the plurality of CS lines 24.

### (Equivalent Circuit for Liquid Crystals of Display Section 2)

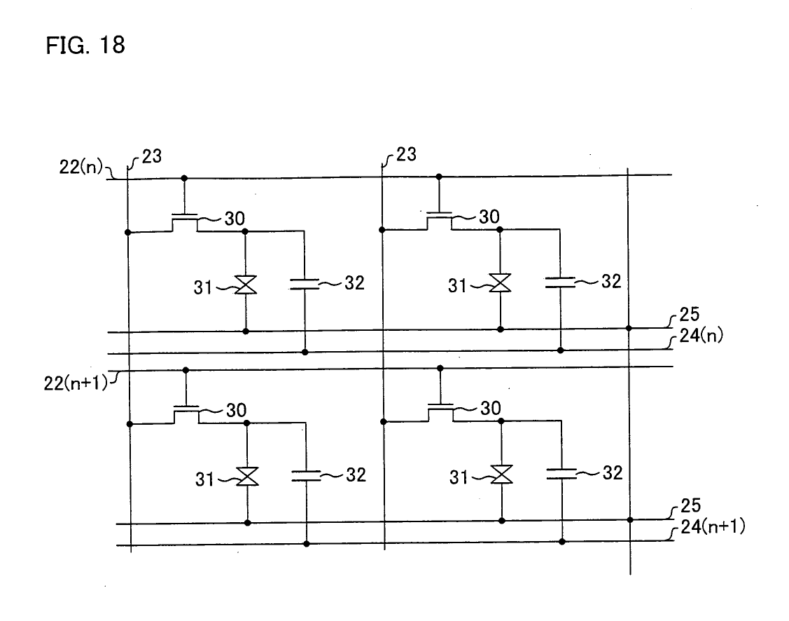

FIG. 18 illustrates an equivalent circuit, for liquid crystals, of the display section 2c. As illustrated in FIG. 18, the display section 2c is configured such that the plurality of COM lines 25 correspond to the respective plurality of gate lines 22, but are short-circuited one another. Accordingly, the COM signal generation section 15 sends out an identical COM signal to all the plurality of COM lines 25 at once. On the other hand, the plurality of CS lines 24 correspond to the respective plurality of gate liens 22, and are electrically insulated from one another. Accordingly, the CS signal generation section 14 sends out an individual CS signal to each of the plurality of CS lines 24 so as to individually change the voltage of each of the plurality of CS lines 24.

Note here that the configuration shown in FIG. 18 is merely an example, and therefore the present invention is not limited to the configuration. For example, voltage input ports of the plurality of CS lines 24 and voltage input ports of the plurality of COM lines 25 can be provided on the same side as those of the plurality of gate lines 22.

### (Overshoot Drive)

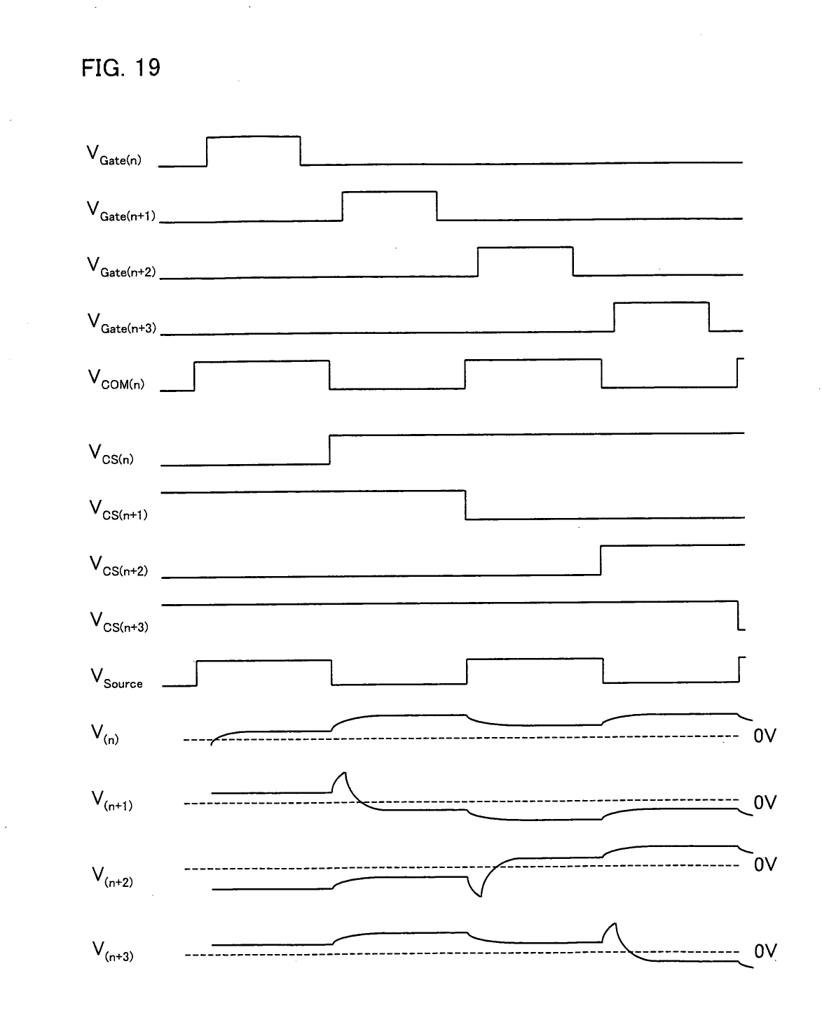

FIG. 15 illustrates waveforms at various points in the display section 2c as observed in a case where the drive circuit 1 carries out the COM drive and the CS drive. Specifically, FIG. 19 illustrates waveforms of voltages (electric potentials) at various points in each of the plurality of pixels 40 as observed in the case where the drive circuit 1 carries out the COM drive. The waveforms of V_{Gate}, V_{Source}) and V_{COM} shown in FIG. 19 are same as those shown in FIG. 16.

According to FIG. 19, the COM signal generation section 15 changes the V_{COM} in a direction opposite to a polarity of the V (n), after the end of the selection period of the pixel 40 but during an n-th horizontal scanning period. According to FIG. 19, a timing of the change in the V_{COM} is same as the timing of the change in the V_{Source} (note however that these timings do not necessarily have to be identical).

As a result of the change, the V (n) here is further shifted in the positive direction. Note here that an amount by which the V (n) is shifted in the positive direction exhibits a characteristic same as that observed when the overshoot drive of the display section 2c is carried out. That is, when a display state of the pixel 40 changes from a state where the liquid crystal applied voltage is small to a state where the liquid crystal applied voltage is large, the following occurs. If the liquid crystal applied voltage is positive in polarity, then the liquid crystal applied voltage is further shifted in the positive direction. On the other hand, if the liquid crystal applied voltage is negative in polarity, then the liquid crystal applied voltage is further shifted in the negative direction. In this way, the pixel 40 is overshoot-driven.

### (Overshoot Drive Caused by COM Drive and CS Drive)

FIG. 16 illustrates waveforms at various points in each of the plurality of pixels 40 as observed in a case where the drive circuit 1 carries out the COM drive and the CS drive. Specifically, FIG. 16 illustrates waveforms of voltages (electric potentials) at various points in each of the plurality of pixels 40 as observed in a case where the drive circuit 1 carries out the COM drive and the CS drive. The waveforms of V_{Gate}, V_{Source}, and V_{COM} shown in FIG. 16 are same as those shown in FIG. 15. On the other hand, the waveform of the V_{CS} is different from that shown in FIG. 15, and its polarity is reversed after the end of the selection period of the pixel 40.

According to FIG. 19, the drive circuit 1 carries out the COM drive and the SC drive after the end of the selection period of the pixel 40. Specifically, the COM signal generation section 15 changes the V_{COM(n)} in a direction opposite to a polarity of the V (n). According to FIG. 19, a timing of the change in the V_{COM(n)} is same as the timing of the change in the V_{Source} (note however that these timings do not necessarily have to be identical). Further, the CS signal generation section 14 changes the V_{CS(n)} in a same direction as the polarity of the V (n). According to FIG. 19, a timing of the change in the V_{CS(n)} is same as the timing of the change in the V_{Source} (note however that these timings do not necessarily have to be identical).

As a result of these changes, the V (n) here is further shifted in a positive direction. Note here that an amount by which the V (n) is shifted in the positive direction exhibits a characteristic same as that observed when the overshoot drive of the display section 2c is carried out. That is, when a display state of the pixel 40 changes from a state where the liquid crystal applied voltage is small to a state where the liquid crystal applied voltage is large, the following occurs. If the liquid crystal applied voltage is positive in polarity, then the liquid crystal applied voltage is further shifted in the positive direction. On the other hand, if the liquid crystal applied voltage is negative in polarity, then the liquid crystal applied voltage is further shifted in the negative direction. In this way, an overshoot-driving effect is attained. The overshoot-driving effect here is a sum of (i) the overshoot-driving effect caused by the COM drive shown in FIG. 4 and (ii) the overshoot-driving effect caused by the CS drive in accordance with the same principle as in the COM drive. As such, the pixel 40 receives a greater overshoot-driving effect. That is, response speed of liquid crystals of the pixel 40 is more improved. Further, the V_{CS(n)} does not return to an initial electric potential for next one vertical scanning period. Therefore, the effective value of the ΔV_{CS} in each vertical scanning period is same as the ΔV_{CS}. As such, the overshoot-driving effect attained is greater than that of Embodiment 1. Note however that in the present embodiment, the V_{COM} is AC-driven so that a polarity thereof is reversed for every horizontal scanning period. Therefore, the effective value of the ΔV_{COM} is less than the ΔV_{COM}. As a result, the effect of the COM drive also becomes small.

The present invention is not limited to the description of the embodiments above, but may be altered within the scope of the claims. In other words, another embodiment is obtainable, on the basis of a proper combination of altered technical means, within the scope of the claims.

For example, the present invention can be arranged such that a voltage V_{Gate} of the gate of the TFT 30 is changed, after the end of the selection period of liquid crystals in the pixel 40, in a same direction as a polarity of the liquid crystal applied voltage. This arrangement also provides the overshoot-driving effect. Alternatively, the present invention can be arranged such that a voltage V_{Source} of the source of the TFT 30 is changed, after the end of the selection period of liquid crystals in the pixel 40, in the same direction as the polarity of the liquid crystal applied voltage. This arrangement also provides the overshoot-driving effect.

The present invention is not limited to the description of the embodiments above, but may be altered within the scope of the claims. In other words, another embodiment is obtainable, on the basis of a proper combination of altered technical means, within the scope of the claims.

For example, the present invention can be arranged such that a voltage V_{Gate} of the gate of the TFT 30 is changed, after the end of the selection period of liquid crystals in the pixel 40, in a same direction as a polarity of the liquid crystal applied voltage. This arrangement also provides the overshoot-driving effect. Alternatively, the present invention can be arranged such that a voltage V_{Source} of the source of the TFT 30 is changed, after the end of the selection period of liquid crystals in the pixel 40, in the same direction as the polarity of the liquid crystal applied voltage. This arrangement also provides the overshoot-driving effect.

### (Separately-Provided Common Electrodes)

The drive circuit in accordance with the present invention is preferably configured such that: the common electrode in the active matrix liquid crystal display panel comprises a plurality of common electrodes that respectively correspond to gate line groups each consisting of a plurality of gate lines that receive voltages having an identical polarity, and the voltage-changing section changes individually a voltage of each of the plurality of common electrodes that respectively correspond to the gate line groups.

According to the configuration, the drive circuit changes only the voltage of the common electrode corresponding to a plurality of pixels that are to be scanned. That is, as to pixels (i.e., pixels that are not to be scanned) other than the pixels that are to be scanned, a pixel electrode corresponding thereto keeps its voltage constant. Accordingly, the pixels that are not to be scanned receive little effect from the above voltage change, and thus the liquid crystal display panel can be driven in a more preferable manner.

### (Independently-Provided Common Electrodes)

The drive circuit in accordance with the present invention is preferably configured such that: the common electrode in the active matrix liquid crystal display panel comprises a plurality of common electrodes that respectively correspond to a plurality of gate lines, and the voltage-changing section changes individually a voltage of each of the plurality of common electrodes that respectively correspond to the plurality of gate lines.

According to the configuration, the drive circuit changes only the voltage of the common electrode corresponding to a plurality of pixels that are to be scanned. That is, as to pixels (i.e., pixels that are not to be scanned) other than the pixels that are to be scanned, a pixel electrode corresponding thereto keeps its voltage constant. Accordingly, the pixels that are not to be scanned receive little effect from the above voltage change, and thus the liquid crystal display panel can be driven in a more preferable manner.

### (Alternate-Current Drive Using Two Different Electric Potentials)

The drive circuit in accordance with the present invention is preferably configured such that: the voltage-changing section alternately applies two different electric potentials to the common electrode in the active matrix liquid crystal display panel. This makes it possible to attain the overshoot-driving effect with the simplest configuration.

### (Timing of Voltage Change)

The drive circuit in accordance with the present invention is preferably configured such that: the voltage-changing section changes, after the end of the selection period of the pixel but during a horizontal scanning period corresponding to the pixel, the voltage of the common electrode in the direction opposite to the polarity of the voltage applied to the liquid crystals in the pixel.

According to the configuration, it is possible to prevent display image distortion.

### (Drive of Storage Capacitor)

The drive circuit in accordance with the present invention further includes: a storage capacitor drive line voltage-changing section for changing, after the end of the selection period of the pixel, a voltage of a storage capacitor drive line corresponding to the pixel, the storage capacitor drive line voltage-changing section changing the voltage of the storage capacitor drive line in a same direction as the polarity of the voltage applied to the liquid crystals in the pixel.

According to the configuration, it is possible to add (i) the overshoot-driving effect caused by making use of the drive of the storage capacitor to (ii) the overshoot-driving effect caused by making use of the drive of the common electrode. As such, it is possible to further improve the overshoot-driving effect.

### (Independently-Provided Storage Capacitor Drive Lines)

The drive circuit in accordance with the present invention is preferably configured such that: the storage capacitor drive line in the active matrix liquid crystal display panel is provided per gate line, and the storage capacitor drive line voltage-changing section changes individually a voltage of the storage capacitor drive line that is provided per gate line, the voltage of the storage capacitor drive line being changed in the same direction as the polarity of the voltage applied to the liquid crystals in the pixel.

According to the configuration, the drive circuit changes only the voltage of the storage capacitor corresponding to pixels to be scanned. That is, as to pixels (i.e., pixels that are not to be scanned) other than the pixels to be scanned, a storage capacitance corresponding thereto keeps its voltage constant. Accordingly, the pixels that are not to be scanned receive little effect from the above voltage change, and thus the liquid crystal display panel can be driven in a more preferable manner.

As described above, the drive circuit in accordance with the present invention includes the voltage-changing section for changing, after the selection period of the pixel included in the liquid crystal display panel, the voltage of the common electrode corresponding to the pixel in the direction opposite to the polarity of the voltage applied to the liquid crystals in the pixel. As such, it is possible to sufficiently overshoot-drive the liquid crystals without requiring additional members which take up much space.

The embodiments discussed in the foregoing description of embodiments and concrete examples serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

The present invention can be widely used as a drive circuit incorporated in an active matrix liquid crystal display device. Further, the present invention can be used as a liquid crystal panel, a liquid crystal module, and a liquid crystal display, device each of which incorporates such a drive circuit.

1. A drive circuit for driving an active matrix liquid crystal display panel, comprising:
voltage-changing means for changing, after an end of a selection period of a pixel in the active matrix liquid crystal display panel, a voltage of a common electrode of the pixel,
the voltage-changing means changing the voltage of the common electrode in a direction opposite to a polarity of a voltage applied to liquid crystals in the pixel.

2. The drive circuit according to claim 1, wherein:
the common electrode in the active matrix liquid crystal display panel comprises a plurality of common electrodes that respectively correspond to gate line groups each consisting of a plurality of gate lines that receive voltages having an identical polarity, and
the voltage-changing means changes individually a voltage of each of the plurality of common electrodes that respectively correspond to the gate line groups.

3. The drive circuit according to claim 1, wherein:
the common electrode in the active matrix liquid crystal display panel comprises a plurality of common electrodes that respectively correspond to a plurality of gate lines, and
the voltage-changing means changes individually a voltage of each of the plurality of common electrodes that respectively correspond to the plurality of gate lines.

4. The drive circuit according to claim 1, wherein:
the voltage-changing means alternately applies two different electric potentials to the common electrode in the active matrix liquid crystal display panel.

5. The drive circuit according to claim 1, wherein:
the voltage-changing means changes, after the end of the selection period of the pixel but during a horizontal scanning period corresponding to the pixel, the voltage of the common electrode in the direction opposite to the polarity of the voltage applied to the liquid crystals in the pixel.

6. The drive circuit according to claim 1, further comprising:
storage capacitor drive line voltage-changing means for changing, after the end of the selection period of the pixel, a voltage of a storage capacitor drive line corresponding to the pixel,
the storage capacitor drive line voltage-changing means changing the voltage of the storage capacitor drive line in a same direction as the polarity of the voltage applied to the liquid crystals in the pixel.

7. The drive circuit according to claim 6, wherein:
the storage capacitor drive line in the active matrix liquid crystal display panel is provided per gate line, and
the storage capacitor drive line voltage-changing means changes individually a voltage of the storage capacitor drive line that is provided per gate line, the voltage of the storage capacitor drive line being changed in the same direction as the polarity of the voltage applied to the liquid crystals in the pixel.

8. A drive circuit, for driving an active matrix liquid crystal display panel, wherein, after an end of a selection period of a pixel in the active matrix liquid crystal display panel, a voltage of a common electrode of the pixel is changed in a direction opposite to a polarity of a voltage applied to liquid crystals in the pixel.

9. A method of driving an active matrix liquid crystal display panel, comprising the step of:
changing, after an end of a selection period of a pixel in the active matrix liquid crystal display panel, a voltage of a common electrode of the pixel, the voltage of the common electrode being changed in a direction opposite to a polarity of a voltage applied to liquid crystals in the pixel.

10. An active matrix liquid crystal display panel, comprising:
a liquid crystal panel substrate, directly on which a drive circuit as set forth in claim 1 is formed.

11. A liquid crystal module, comprising:
an active matrix liquid crystal display panel; and
a drive circuit as set forth in claim 1.

12. A liquid crystal display device, comprising:
a liquid crystal display panel as set forth in claim 10.

13. A liquid crystal display device, comprising:
a liquid crystal module as set forth in claim 11.
